(19) United States
(12) Patent Application Publication
(10) Pub. No.: US 2012/0071285 A1
(43) Pub. Date: Mar. 22, 2012

(54) Tooth Designs for Block Transmission Belts

(76) Inventor: Armin Sebastian Tay, West Covina, CA (US)

(21) Appl. No.: 13/233,864

(22) Filed: Sep. 15, 2011

Related U.S. Application Data
(60) Provisional application No. 61/403,485, filed on Sep. 16, 2010.

(51) Int. Cl. F16G 1/28

(52) U.S. Cl. 474/202

(57) ABSTRACT

An inclined partial cylinder tooth shape for a block transmission belt that can be used with single tooth cones, cones with two opposite teeth, and transmission pulleys. Said inclined partial cylinder tooth shape allows for full surface to surface contact engagement between the engaging surfaces used for torque transmission in transmissions using block transmission belts, which is not achievable with currently known tooth shapes for a block transmission belt.

### CROSS REFERENCE TO RELATED APPLICATIONS

This invention is entitled to the benefit of Provisional Patent Application (PPA) Ser. No. 61/403,485 filed on Sep. 16, 2010.

### BACKGROUND

1. Field of Invention

This invention relates to a power transmission belt, specifically to a power transmission belt that can be used for a transmission that uses a cone with a single tooth (single tooth cone) or a pulley with a conical shaped base. This invention also relates to a transmission, specifically a transmission that uses a cone with two opposite teeth that is coupled by a transmission belt to a transmission pulley.

2. Description of Prior Art

A block transmission belt, which is a belt that consist of alternating arrangement of flexible blocks and not so flexible blocks (preferably solid blocks) on which a tooth shape is shaped (the flexible blocks alternate with the not so flexible blocks/tooth blocks) and is shown as a side-view in FIG. 1A and as an sectional-view in FIG. 1B, was disclosed in patent application Ser. No. 12/459,853.

A block transmission belt can be used with a single tooth cone, which is shown as a side-view in FIG. 2A and as a front-view in FIG. 2B; a cone with two opposite teeth, which is shown as a side-view in FIG. 3A and as a front-view in FIG. 3B; and a transmission pulley, which is shown as a side-view in FIG. 4A and as a front-view in FIG. 4B. A single tooth cone, cone with opposite teeth, and the transmission pulley were also disclosed in patent application Ser. No. 12/459,853.

In patent application Ser. No. 12/459,853, an involute tooth shape is recommended for the tooth/teeth of a single tooth cone, a cone with two opposite teeth, a transmission pulley, and the tooth blocks of a block transmission belt. The use involute tooth shapes results in line contact engagement between two mating involute tooth shape teeth. The amount of force that can be transmitted between two mating teeth depends on the contact engagement area between the two mating teeth. Line contact engagement provides a relatively small contact area and hence limits the amount of force that can be transmitted between two engaging teeth.

In this disclosure we introduce tooth shapes for a block transmission belt and mating tooth shapes for a single tooth cone, a cone with two opposite teeth, and/or a transmission pulley that can allow for full surface to surface contact engagement. Full surface to surface contact engagement between engaging teeth will increase the amount of force that can be transmitted between the engaging teeth immensely.

In addition, a CVT that uses a cone with two opposite teeth that is coupled to a transmission pulley by a transmission belt is also described in this disclosure. This set-up is probably that simplest set-up for a non-friction CVT and will be referred to as a CVT 3.

### SUMMARY

It is an object of this invention to provide alternate tooth shapes that can be used for a single tooth cone, a cone with two opposite teeth, and/or a transmission pulley; and to provide alternate tooth shapes for a block transmission belt that allow for full surface to surface contact engagement between engaging teeth.

It is another object of this invention to describe a simple non-friction CVT.

### OBJECTS AND ADVANTAGES

Accordingly some of the objects and advantages of the present invention are:
(a) To provide alternate tooth shapes for a block transmission belt that allow for full surface to surface contact engagement.
(b) To provide alternate tooth shapes that can be used for a single tooth cone, a cone with two opposite teeth, and/or a transmission pulley that allow for full surface to surface contact engagement.
(c) To provide a non-friction CVT that is as simple as possible.

### DRAWING FIGURES

FIG. 1A shows a side-view of a block transmission belt that was disclosed in patent application Ser. No. 12/459,853.

FIG. 1B shows a sectional-view of a block transmission belt that was disclosed in patent application Ser. No. 12/459,853.

FIG. 2A shows a side-view of a single tooth cone that was disclosed in patent application Ser. No. 12/459,853.

FIG. 2B shows a front-view of a single tooth cone that was disclosed in patent application Ser. No. 12/459,853.

FIG. 3A shows a side-view of a cone with two opposite teeth that was disclosed in patent application Ser. No. 12/459,853.

FIG. 3B shows a front-view of a cone with two opposite teeth that was disclosed in patent application Ser. No. 12/459,853.

FIG. 4A shows a side-view of a transmission pulley that was disclosed in patent application Ser. No. 12/459,853.

FIG. 4B shows a front-view of a transmission pulley cone that was disclosed in patent application Ser. No. 12/459,853.

FIGS. 5, 6, 7, 8, and 9 show a partial front-view of a circular arc tooth profile, which is the preferred tooth profile of the present invention.

FIG. 10 shows a partial front-view of tooth profile that uses the shape or portions of the shape between two sprocket shaped teeth. This tooth profile is an alternate embodiment of the invention and is referred to as the sprocket tooth profile.

FIG. 11 shows a side-view of a cylindrical teeth block transmission belt 3, which uses the preferred tooth profile of the present invention for a block transmission belt.

FIG. 12 shows a sectional-view of a cylindrical teeth block transmission belt 3.

FIG. 13 shows a top-view of a cylindrical teeth block transmission belt 3.

FIG. 14 shows a square tooth shape of a single tooth cone. This tooth shape can also be used for a cone with two opposite teeth, a transmission pulley, and other means for conveying rotational energy. This tooth shape is an alternate embodiment of the invention.

FIG. 15 shows a side-view of a square teeth block transmission belt 9. This transmission belt is an alternate embodiment of the invention.

FIG. 16 shows a sectional-view of a square teeth block transmission belt 9.

FIG. 17 shows a top-view of a square teeth block transmission belt 9.

FIG. 18 shows a partial front-view of a square tooth shape of a single tooth cone with a round top portion instead of square top portion.

FIG. 19 shows a side-view of a rubber belt 15. This transmission belt is an alternate embodiment of the invention.

FIG. 20 shows a sectional-view of a rubber belt 15.

FIG. 21 shows a side-view of a rubber belt on which reinforcement plates 17 are attached. This transmission belt is an alternate embodiment of the invention.

FIG. 22 shows a sectional-view of a rubber belt on which reinforcement plates 17 are attached.

FIG. 23 shows a side-view of a rubber belt that has engaging plates 18. This transmission belt is an alternate embodiment of the invention.

FIG. 24 shows a side-view of a cone assembly that has one sliding tooth.

FIG. 25 shows a sectional-view of a cone assembly that has one sliding tooth.

FIG. 26 shows a side-view of a sliding tooth block transmission belt 19. This transmission belt is an alternate embodiment of the invention.

FIG. 27 shows a sectional-view of a sliding tooth block transmission belt 19.

FIG. 28 shows a top-view of a sliding tooth block transmission belt 19.

FIG. 29 shows a side-view of a block transmission belt that can be used with the cone assembly with one sliding tooth that has a sliding tooth that has a circular arc tooth profile or a tooth profile that use the space or portions of the space between two sprocket shaped teeth. This transmission belt is an alternate embodiment of the invention.

FIG. 30 shows a sectional-view of a block transmission belt that can be used with the cone assembly with one sliding tooth that has a sliding tooth that has a circular arc tooth profile or a tooth profile that use the space or portions of the space between two sprocket shaped teeth.

FIG. 31 shows a top-view of a block transmission belt that can be used with the cone assembly with one sliding tooth that has a sliding tooth that has a circular arc tooth profile or a tooth profile that use the space or portions of the space between two sprocket shaped teeth.

FIG. 32 shows a partial front-view of a partial cylinder tooth profile. This tooth profile is an alternate embodiment of the invention.

FIG. 33 shows a side-view of a block transmission belt 23. This transmission belt is an alternate embodiment of the invention.

FIG. 34 shows a sectional-view of a block transmission belt 23.

FIG. 35 shows a side-view of a block transmission belt 23 for which the rear arc angle 28 and a front arc angle 29 each measure 90 degrees.

FIG. 36 shows a side-view of a block transmission belt with alternate tooth blocks 26A, for which the engaging surfaces measured by rear arc angle 28 are removed.

FIG. 37 shows a side-view of a block transmission belt with alternate tooth blocks 26B, for which the engaging surfaces measured by rear arc angle 28 are set to 30 degrees or about 30 degrees (not 0 degrees and not 90 degrees).

FIG. 38 shows a side-view of a block transmission belt with alternate tooth blocks 26C, for which the engaging surfaces measured by front arc angle 29 are greater than 90 degrees.

FIG. 39 shows a partial front-view of a tooth profile for a single tooth cone (which has an engaging front arc angle that is greater than 90 degrees).

FIG. 40 shows a partial side-view of a transmission belt 40 that can be used with the tooth profiles of FIGS. 5, 6, 7, 8, 9, and 10. This transmission belt is an alternate embodiment of the invention.

FIG. 41 shows an end-view of a transmission belt 40 that can be used with the tooth profiles of FIGS. 5, 6, 7, 8, 9, and 10.

FIG. 42 shows a partial side-view of a transmission belt 43 that can be used with the tooth profiles of FIGS. 5, 6, 7, 8, 9, and 10. This transmission belt is an alternate embodiment of the invention.

FIG. 43 shows an end-view of a transmission belt 43 that can be used with the tooth profiles of FIGS. 5, 6, 7, 8, 9, and 10.

FIG. 44A shows a partial front-view of CVT 2 where the transmission belts are positioned near the smaller end of their single tooth cones.

FIG. 44B shows a partial top-view of CVT 2 where the transmission belts are positioned near the smaller end of their single tooth cones.

FIG. 45A shows a partial front-view of CVT 2 where the transmission belts are positioned near the larger end of their single tooth cones.

FIG. 45B shows a partial top-view of CVT 2 where the transmission belts are positioned near the larger end of their single tooth cones.

FIG. 46A shows a partial front-view of CVT 3 where the transmission belt is positioned near the smaller end of its cone with two oppositely positioned teeth.

FIG. 46B shows a partial top-view of CVT 3 where the transmission belt is positioned near the smaller end of its cone with two oppositely positioned teeth.

FIG. 47A shows a partial front-view of CVT 3 where the transmission belt is positioned near the larger end of its cone with two oppositely positioned teeth.

FIG. 47B shows a partial top-view of CVT 3 where the transmission belt is positioned near the larger end of its cone with two oppositely positioned teeth.

### DESCRIPTION OF INVENTION

In this disclosure alternate tooth shapes for a single tooth cone and a block transmission belt that can be used to construct a transmission such as a CVT 2 described in patent application Ser. No. 12/459,853 and a CVT 3 described in this disclosure.

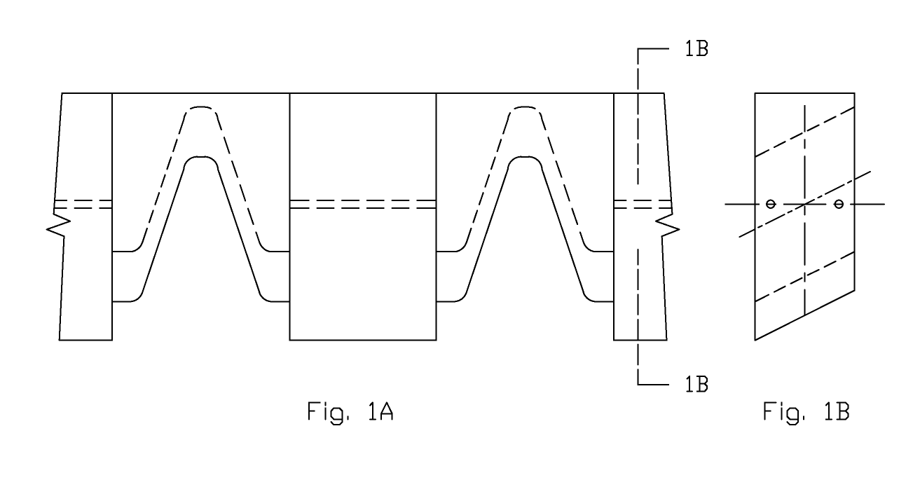

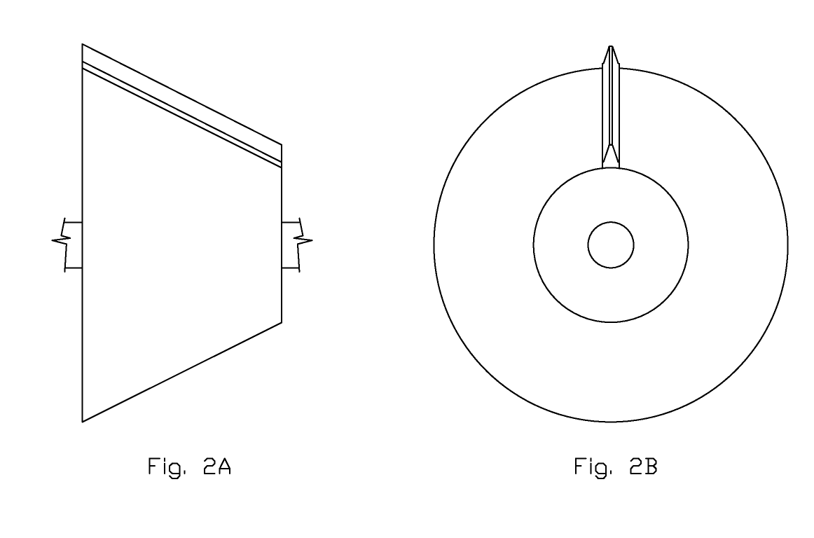

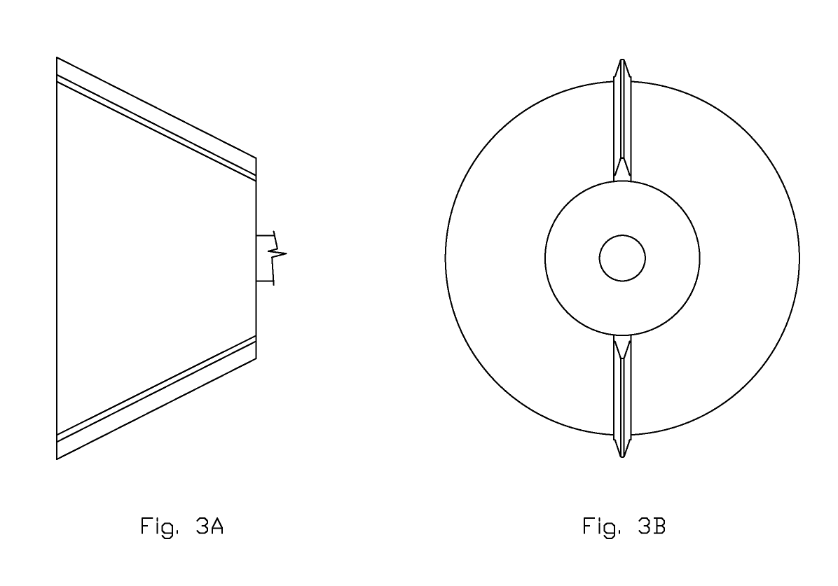

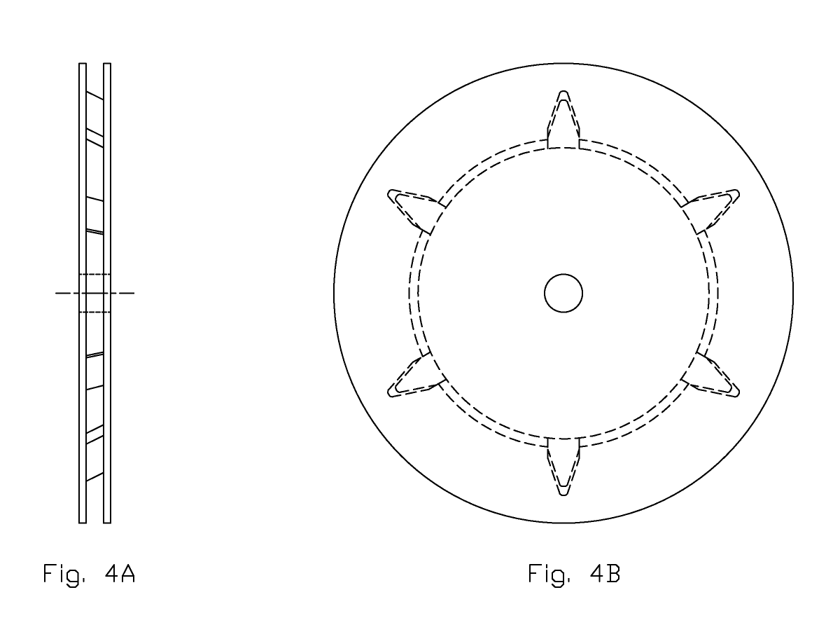

A single tooth cone, a cone with two opposite teeth, a transmission pulley that can be used with a block transmission belt, and a block transmission belt are described in patent application Ser. No. 12/459,853. And in this disclosure, a single tooth cone is shown as a side-view in FIG. 2A and as a front-view in FIG. 2B; a cone with two opposite teeth is shown as a side-view in FIG. 3A and as a front-view in FIG. 3B; a transmission pulley that can be used with a block transmission belt is shown as a side-view in FIG. 4A and as a front-view in FIG. 4B; and a block transmission belt is shown as a side-view in FIG. 1A and as an sectional-view in FIG. 1B.

In order to couple a single tooth cone, a cone with two opposite teeth, or a transmission pulley on one shaft with a single tooth cone, a cone with two opposite teeth, or a transmission pulley on another shaft, an inverted tooth chain or silent chain, that is slightly modified for a conical base shape instead of a round base shape can be used. Here the shape of the single tooth cone, the cone with two opposite teeth, and/or and the transmission pulley, as well as the shape of their teeth, should be made such that they can properly engage with the slightly modified inverted tooth chain or slightly modified silent chain. All design techniques used for inverted tooth chains and silent chains can also be used or slightly adapted to the situation here.

If an involute tooth shape is used, it is recommended that the tooth/teeth of the single tooth cone, the cone with two opposite teeth, and/or the transmission pulley have the shape of an involute tooth, which has a slightly convex engagement surfaces which are facing away from each other. And for the tooth cut-outs of the tooth blocks of the block transmission belt or the chain links of a chain, it is recommended that the tooth cut-outs have the shape of a space between two involute teeth, which has slightly convex engagement surfaces that are facing towards each other.

Also, it is recommended that for a block transmission belt, the rubber blocks are spaced sufficiently apart and shaped so that they don't come into contact with the tooth/teeth with which its block transmission belt engages.

If through experimentations it was determined that an involute tooth shape of a single tooth cone, a cone with two opposite teeth, and/or a transmission pulley, mated with a space between two involute teeth of a block transmission belt does not provide smooth or desired engagement, then the involute tooth shape and the space between two involute teeth shape can be slightly modified. Here experimentation and trial and error can be used. For example, experimentation and trial and error can be used to determine the engaging surfaces which prevent smooth engagement so that these surfaces can be removed/reshaped.

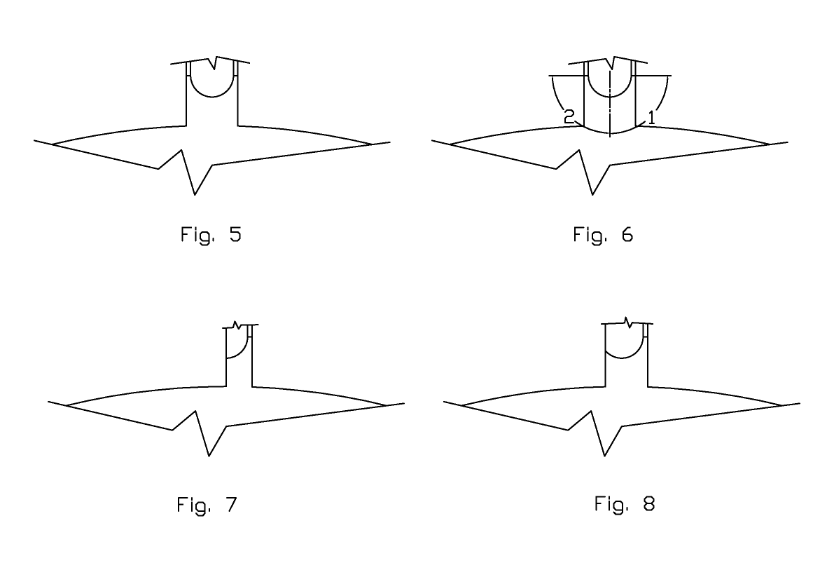

A preferred tooth profile of this invention that can be used as the tooth profile for the single tooth cones and the tooth profile of the teeth of the pulleys to which the single tooth cones are coupled is shown as a partial front-view in FIG. 5. This tooth profile is labeled as the circular arc tooth profile.

The lower portion of the circular arc tooth profile has the shape of a rectangle, this is shape is of little significance since only the upper portion of the circular arc tooth profile engages for torque transmission with its chain or transmission belt; it can have the shape of a square, triangle, or whatever other shape as long as it doesn't interfere or significantly interfere with a surface of the transmission belt or chain with which it engages and as long it has sufficient strength as required by the operation where it is used. If it is determined to be desirable (through experimentation, etc.), the lower portion of the circular arc tooth profile can be omitted, so that the circular arc tooth profile only consist of the upper portion of the circular arc tooth profile, which is described in the next paragraph.

The upper portion of the circular arc tooth profile has the shape that is identical to the inner surface of an inclined hollow cylinder (which inclined angle should correspond or be identical to the inclined angle of its cone) for which a portion of the inner surface is removed. Since a portion of the inner surface is removed, in order to specify the amount of the inner surface that is not removed, a rear arc angle 1 and a front arc angle 2 measurement labeling, which both start at the 6 o'clock position, is used (see FIG. 6).

For the circular arc tooth profile shown in FIG. 6, the rear arc angle 1 and a front arc angle 2 each measure 90 degrees. The engaging surface measured by rear arc angle 1 provides an engaging surface for torque transmission in one rotational direction and the engaging surface measured by front arc angle 2 provides an engaging surface for torque transmission in the opposite rotational direction from the rotational direction where torque transmission is provided by the engaging surface measured by rear arc angle 1. When not used for torque transmission, the engaging surfaces can also be used to help maintain the shape of the transmission belt with which their circular arc tooth profile engages. Here the larger the arc angle, the larger the engaging surface that can be used for torque transmission and the larger the transmission belt shape maintaining support engaging surface. So it is desirable to have the largest rear arc angle 1 and the largest front arc angle 2 that allows for smooth/acceptably smooth torque transmission engagement.

A computer model or a real world model can be used to determine the largest rear arc angle 1 and the largest front arc angle 2 that allows for smooth/acceptably smooth engagement between the tooth of the single tooth cone and its chain or its transmission belt. Here the interfering surfaces that cause unacceptable engagement (not smooth enough) can be identified and simply removed or reshaped.

Without the use of a model, we can assume that for rotation in the counter-clockwise direction for the single tooth cone which tooth is shown in FIG. 6 (said single tooth cone is on the driving shaft), the engaging surface measured by front arc angle 2 will not allow for smooth/acceptably smooth engagement. In order to allow for smooth/acceptably smooth engagement in the specified direction of rotation, we can simply remove the interfering surface that will not allow for smooth/acceptably smooth engagement, which we can assume is the engaging surface measured by front arc angle 2. An alternate circular arc tooth profile where the engaging surface measured by front arc angle 2 is removed (the front arc angle 2 is set to 0 degrees) to allow for smooth/acceptably smooth engagement is shown in FIG. 7.

The alternate circular arc tooth profile shown in FIG. 7 only allows for torque transmission in one direction, since the engaging surface measured by front arc angle 2 is removed, and it does have not the transmission belt shape maintaining support surface provided by front arc angle 2. In order for the CVT/transmission using this tooth profile to work properly it might be necessary to use a clutch that only allows torque transmission in one-direction and that also slips when torque is applied in the direction opposite of the direction that allows torque transmission, or another device or procedure that allows for proper operation of the CVT/transmission using this tooth profile. This is certainly an inconvenience; therefore, instead of completely removing the engaging surface measured by front arc angle 2, we might instead reduce the engaging surface measured by front arc angle 2 just enough as to allow for smooth/acceptably smooth engagement (for example instead of setting the front arc angle 2 to 0 degrees, we might set it to 50 degrees). An example of this alternate circular arc tooth profile is shown in FIG. 8. Here we can use a model and run the model using simulation or an experiment to determine if for example a front arc angle 2 of 50 degrees allows for smooth/acceptably smooth engagement or not, if not then we need to reduce front arc angle 2 until a front arc angle 2 that is small enough to allow for smooth/acceptably smooth engagement is determined, and if yes we can accept a front arc angle 2 of 50 degrees or increase the front arc angle 2 until the largest front arc angle 2 that allows for smooth/acceptably smooth engagement is determined.

Also for rotation in the counter-clockwise direction, for the single tooth cone which circular arc tooth profile is shown in FIGS. 7 and 8, a rear arc angle 1 that is greater or less than 90 degrees might be used, here as described earlier, simulations or experiments using a model can be used to determine the maximum rear arc angle 1 that allows for smooth/acceptably smooth engagement, which might be greater or less than 90 degrees.

The tooth profiles shown in FIGS. 7 and 8, are shaped for counter-clockwise rotation of the single tooth cone or pulley of those tooth profiles when the single tooth cone or pulley of those tooth profiles is on the input shaft; and shaped for clockwise rotation of the single tooth cone or pulley of those tooth profiles when the single tooth cone or pulley of those tooth profiles is on the output shaft.

For clockwise rotation of the single tooth cone or pulley of those tooth profiles when the single tooth cone or pulley of those tooth profiles is on the input shaft, and counter-clockwise rotation of the single tooth cone or pulley of those tooth profiles when the single tooth cone or pulley of those tooth shapes is on the output shaft, the angle for the rear arc angle 1 and the angle for the front arc angle 2 can simply be swapped, which results in a minor image of the tooth profiles shown in FIGS. 7 and 8.

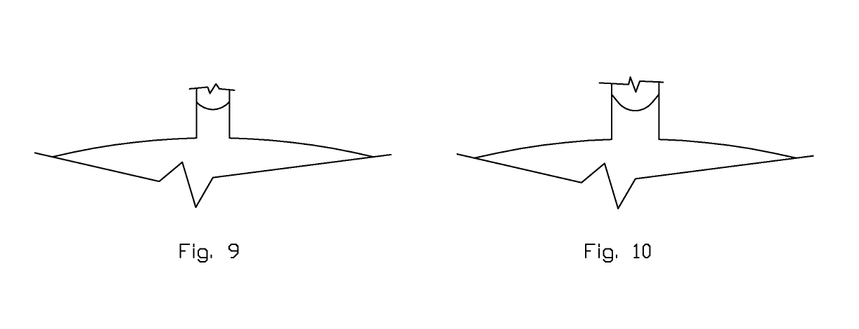

While the circular arc tooth profiles shown in FIGS. 7 and 8 are designed to only transmit torque in one rotational direction, a circular arc tooth profile that can transmit torque in both rotational directions can also be designed. Again, as described earlier here simulations or experiments using a model can be used to determine the maximum rear arc angle 1 and the maximum front arc angle 2 that allows for smooth/acceptably smooth engagement for torque transmission in both directions of rotation. A circular arc tooth profile with this intention in mind is shown in FIG. 9.

A circular arc tooth profile is designed to engage with a tooth that is shaped like a cylinder or partial cylinder (cylindrical or partially cylindrical shaped teeth). It is known that a sprocket can engage with cylindrical shaped teeth. Therefore, we can assume that sprocket shaped teeth can be used for a single tooth cone that uses a transmission belt such as a block transmission belt that uses cylindrical or partially cylindrical shaped teeth, which is the kind of transmission belt that is also used for the circular arc tooth profiles described earlier. A tooth profile that uses the shape or portions of the shape between two sprocket shaped teeth that can be used with a block transmission belt that uses cylindrical or partially cylindrical shaped teeth is shown in FIG. 10, which is meant to show a tooth profile that uses the shape or portions of the shape between two sprocket shaped teeth although it might not be accurately drawn. Like all tooth shapes of a single tooth cone, this tooth shape also elongates from a smaller end to a larger end of its cones, and is inclined at the same/corresponding angle as the incline of its cone. If desired, the shape of this tooth profile can (smoothly) change as the diameter of the surface of its cone is changed, since the shape between two sprocket shaped teeth change as the diameter of the sprocket is changed. Experiments or simulations using a model can be performed to determine the best shape for this tooth profile, including whether changing the tooth shape with change in diameter is desirable or not, so as to allow optimum performance (smooth and secure/reliable engagement). This tooth profile is an alternate embodiment of the invention and is referred to as the sprocket tooth profile.

Somebody skilled in the art should be able to construct a pulley out of the tooth profiles described above. Here, a pulley is similar to a short cone where instead of one tooth, multiple teeth are positioned preferably equally spaced apart around the circumference of the cone on the surface of the cone, at the same pitch as the pitch of its transmission belt or chain. Teeth can be skipped if it allows for smoother engagement as long as one tooth is engaged during all instances of the operation of the device where the pulley is used. And in order to maintain the axial alignment of the transmission belt relative to its pulley, the pulley can have flanges.

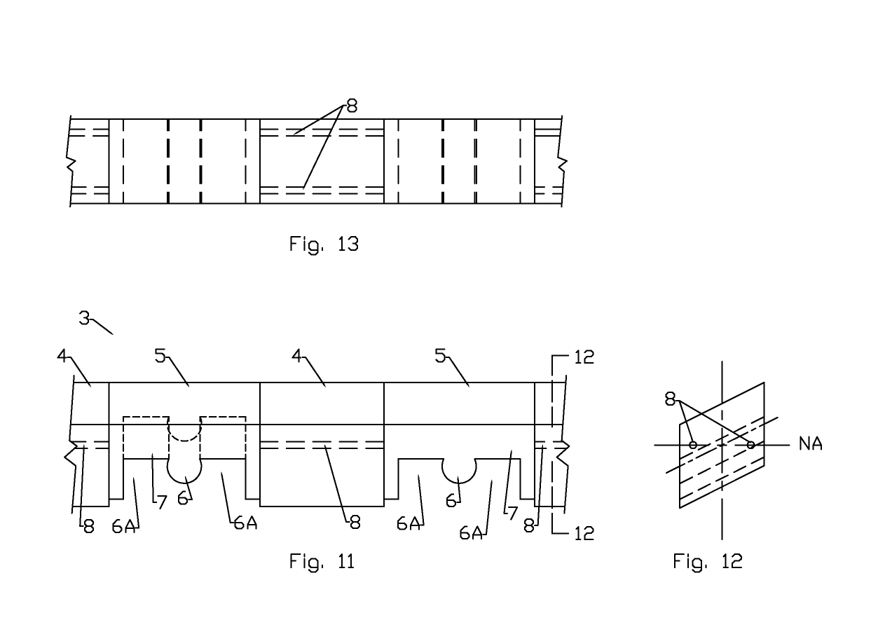

A block transmission belt that can be used with a circular arc tooth profile and sprocket tooth profile is shown as a side-view in FIG. 11, as a sectional-view in FIG. 12, as a top-view in FIG. 13. It is labeled as cylindrical teeth block transmission belt 3; and its rubber blocks are labeled as rubber blocks 4, its rubber block reinforcements as rubber block reinforcements 8, and its tooth blocks as tooth blocks 5. For clarity the hidden lines in the side-view of one tooth block 5 are not shown (see FIG. 11). The rubber blocks 4 can be attached to their tooth blocks 5 using adhesives.

A tooth block 5 consists of a tooth shape 6 and a supporting surface for tooth shape 6, labeled as supporting surface 7. Tooth shape 6 is shaped like an inclined partial cylinder, which incline should match the incline of the circular arc tooth or sprocket tooth of its single tooth cone and/or pulley with which it engages. The percentage of the inclined cylinder shape of tooth shape 6 that is shaped like an inclined cylinder should be large enough so that the circular arc teeth or sprocket tooth with which tooth shape 6 engages, engage with an inclined cylinder shape and not with a portion of supporting surface 7. Supporting surface 7 should be shaped so that it doesn't interfere or excessively interfere with any portions of the single tooth cone and/or pulley with which it engages.

As can be seen from FIG. 12, the centers of the inclined cylinders of tooth shapes 6 (shown as an angled center-line), at the mid-width of tooth blocks 5, are located at the neutral-axis (shown as a horizontal center-line) of rubber blocks 4; if no optimizing experimentations are to be performed, this is the preferred location of the neutral-axis. Placing the neutral-axis in this way allows the avoidance of a bending moment in a cylindrical teeth block transmission belt 3 due to the engagement between a tooth of a cone or pulley and a tooth shape 6 of said cylindrical teeth block transmission belt 3. Also by placing the neutral-axis in this way, the arc lengths between the center of the inclined cylinder of tooth shape 6 at the mid-width of the tooth blocks 5 remain constant or almost constant regardless of the diameter of the surface of the cone where said cylindrical teeth block transmission belt 3 is positioned. If for some reasons a bending moment in a cylindrical teeth block transmission belt 3 due to the engagement between a tooth of a cone or pulley and a tooth shape 6 of said cylindrical teeth block transmission belt 3 is not avoided by placing the neutral-axis in this way, then experimentations can be used to determine the proper location of the neutral-axis for said cylindrical teeth block transmission belt 3 so as to avoid a bending moment. Experimentations to determine the desired location of the neutral-axis for a cylindrical teeth block transmission belt 3 simply involve raising and/or lowering the neutral-axis until the location of the desired neutral-axis is determined.

Also all descriptions regarding the neutral-axis as well as all other descriptions for a block transmission belt described in patent application Ser. No. 12/459,853, also apply to all block transmission belts in this disclosure. Also, if a transmission belt, including a block transmission belt, is used for a transmission where the transmission ratio is changed (obviously a transmission where the transmission ratio can be changed can also be used as a transmission where the transmission ratio is not changed), then the location of the neutral-axis of said transmission belt will influence the required amount of adjustments to compensate for transition flexing and transmission ratio change rotation, unless the neutral-axis is positioned so that no change in distance between the teeth (no change in the distance between the center of the inclined cylinder of tooth shapes 6 at the mid-width of the tooth blocks 5) of said transmission belt occur as the diameter of the surface where it is positioned is changed. This is because the change in distance between the teeth of transmission belt as the transmission diameter of its cone is changed depends on the location of the neutral-axis of said transmission belt, unless the neutral-axis is positioned so that no change in distance between the teeth of said transmission belt occur as the diameter of the surface where it is positioned is changed. For belts where multiple teeth are engaged with a section of a cone, then positioning the neutral-axis so that no change in distance between the teeth of a transmission belt, including a block transmission belt, as the transmission diameter of its cone is changed is desired; here the position of the neutral-axis can be determined using engineering principles, and/or experimentation, for example.

Since for a single tooth cone and a cone with two oppositely positioned teeth only one tooth is positioned at a section of a cone, the neutral-axis of a transmission belt, including a block transmission belt, used with a single tooth cone and a cone with two oppositely positioned teeth does not have to be positioned so that that no changes in the distance between the teeth of the transmission belt occur as the transmission diameter of its cone is changed. Here, regardless of the position of the neutral-axis of a transmission belt, if the transmission belts are used for a CVT 2 that uses two single tooth cones, then perfect engagement can only be achieved at certain transmission diameters of the single tooth cones (which depends on the axial position of the transmission belts on their cones) unless adjusters to compensate for transition flexing are used; and if the transmission belt is used with a CVT 3 that uses a cone with two oppositely positioned teeth (a cone with two oppositely positioned teeth can be used to replace a cone with two oppositely positioned torque transmitting members for all basic configurations of a transmission/CVT; like a cone with two oppositely positioned torque transmitting members, a cone with two oppositely positioned teeth also has two oppositely positioned torque transmitting sections, here the amount of teeth at a given section of a cone is not relevant to what basic configuration of a transmission/CVT said cone can be used), then perfect engagement can only be achieved at certain transmission diameters of the cone with two oppositely positioned teeth. Here experiments or simulations using transmission belts with different locations of the neutral-axis can be performed to determine whether changing the locations of the neutral-axis has any effect on the performance of the system (transmission); and if it does, the experiments can be used to determine the location of the neutral-axis that allows for optimum performance (optimum smoothness, more efficient and effective tooth shapes, etc.). Also here for a CVT 2, the amount of adjustment to compensate for transition flexing required for given neutral-axis can be determined through experiment, math, etc.

Instead of having tooth shape 6 shaped like an inclined partial cylinder that has a round cross-section, an inclined partial cylinder that has an elliptical, an oval, or a cog tooth shaped cross-section can also be used as long as the tooth of its cone is modified accordingly; here experimentations can be performed to see if this has any benefits.

Also in order to have smoother engagement between the tooth/teeth of a cone and the teeth of its transmission belt in situations where the teeth don't perfectly engage, a transmission belt can be made so that its teeth can rotate/twist along its length more easily. This can be achieved by having the most strength of a transmission belt provided by its reinforcements and by making the rubber portion of that transmission belt very flexible. Here if the reinforcements are located at the neutral-axis, then the teeth/tooth blocks can easily pivot/twist about the neutral-axis (the locations of the reinforcements determines the pivot point at which the teeth/tooth blocks can easily twist/rotate). And in order to reduce undesired twisting of the transmission belt due to torque transmission, the tension in the slack side of the rubber belt can be increased and/or additional supporting pulleys that push the rubber belt towards the surface of its cone can be used.

Also obviously the “Gap between teeth” method described in patent application Ser. No. 12/459,853 can also be used with a single tooth cone and its transmission belts, including block transmission belts. The “Gap between teeth” method can provide smoother engagement, allow for larger engagement surfaces between the tooth of a single tooth cone or the teeth of a pulley and the teeth of their transmission belt(s), reduce the accuracy requirement in controlling the adjuster(s), etc.

For the “Gap between teeth method”, the spaces of the transmission belt where a tooth of its cone/pulley will be positioned is wider than the width of the tooth/teeth of its cone (said spaces are labeled as space 6A in FIG. 11), while the pitch for the teeth of the transmission belt and the pitch for the teeth of its cone should be equal if a cone that has multiple teeth at a section is used. If a cone only has one tooth, than the equal pitch requirement is irrelevant, since a cone with one tooth does not have a pitch (pitch measures the distance from one tooth to the next tooth).

Here, the requirement for the pulley/transmission pulley is that it can smoothly engage with its transmission belt. Also, since a pulley/transmission pulley might be used to adjust the rotational position of its transmission belt, it is desirable that the rotational position of a pulley/transmission pulley relative to its transmission belt has minimum amount of play so as to maximize the accuracy of the adjustment provided; in addition, here minimum amount of play also minimizes the impact force during initial engagement.

The tooth engagement procedure for the “Gap between teeth method” is as follows: when a tooth of a cone/cone assembly is about to be engaged, the rotational position of its cone/cone assembly is in a manner so that said tooth of a cone/cone assembly is positioned in a space between a tooth of its transmission belt which it will eventually engage and an end surface (which can also be in the shape of tooth) during initial mating between said tooth of a cone/cone assembly and its transmission belt; here an adjuster might need to be used to ensure this (an example of a said space is shown and labeled as space 6A in FIG. 11; two spaces 6A are shown for each tooth of the transmission belt, but said tooth of a cone/cone assembly is only positioned in one space 6A; the space 6A where said tooth of a cone/cone assembly will be positioned depends on the rotation of the cone/cone assembly and the configuration of the transmission/CVT; for example if the circular arc tooth profile of FIG. 7 is used and the cone of the circular arc tooth profile of FIG. 7 is mounted on the input shaft and rotating counter-clockwise, then said tooth of a cone/cone assembly should be positioned in a space 6A that is to the right of its tooth shape 6, since it is the space 6A where said tooth of a cone/cone assembly should be positioned as to allows for proper torque transmission). Then once that tooth is positioned in said space, an adjuster rotates said tooth of a cone/cone assembly relative to its transmission belt or its transmission belt relative to said tooth of a cone/cone assembly so that said tooth of a cone/cone assembly engages with said tooth of its transmission belt for torque transmission, this adjustment will be referred to as engaging adjustment. If a cone/cone assembly with a torque transmitting member is used, then when the first tooth (the tooth that gets to engage first) of a cone/cone assembly is about to be engaged, the rotational position of its cone/cone assembly is in a manner so that said first tooth is positioned in a said space during initial mating between its torque transmitting member and its transmission belt, here an adjuster might need to be used to ensure this; then once said first tooth is positioned in a said space, an adjuster rotates the torque transmitting member of said first tooth relative to its transmission belt or its transmission belt relative to the torque transmitting member of said first tooth so that the teeth of the torque transmitting member of said first tooth engage with the teeth of its transmission belt for torque transmission, this adjustment will also be referred to as engaging adjustment.

In order for the adjuster to know when to initiate engagement for torque transmission between “a tooth positioned in a said space (a space between a tooth of its transmission belt which it will eventually engage and an end surface) and its transmission belt” or “teeth of a torque transmitting member that are each positioned in a said space and its transmission belt” (initiate engaging adjustment), rotational position sensor(s) that monitor the rotational position of the cone/cone assembly of said tooth/torque transmitting member can be used. Obviously here engaging adjustment for “a tooth”/“teeth of a torque transmitting member” should be initiated while that tooth/those teeth of that torque transmitting member “is”/“are each” positioned in a said space, and preferably it should be initiated as soon as “a tooth”/“the first tooth of a torque transmitting member” is positioned in a said space. Here it can be estimated through mathematics, experimentation, simulations, and/or other methods, at what rotational position “a tooth”/“the first tooth of a torque transmitting member” is positioned in a said space (or a different engaging adjustment initiation rotational position criteria can also be used) for each transmission ratio of its transmission/CVT, then this estimation can be programmed into the controlling computer so that the controlling computer with the information from the rotational position sensor(s) and transmission ratio sensor(s) can estimate when to initiate engaging adjustment.

Once a tooth positioned in a said space (a space between a tooth of its transmission belt which it will eventually engage and an end surface) due to engaging adjustment, the adjuster that provides the engaging adjustment should stop, stall and then stop, or stall. Obviously when stalled the adjuster that provides engaging adjustment should not cause any damaging stresses in the transmission, here the strength of the adjuster can be limited as such or a slipping clutch can be used. And in order to know when to stop engaging adjustment, the rotational position sensor(s) that monitor the rotational position of the cone/cone assembly of said tooth can be used to determine when engagement for torque transmission has occurred. Here it can be estimated through mathematics, experimentation, simulations, or other methods, at what rotational position “a tooth”/“torque transmitting member” engages for torque transmission with its transmission belt for each transmission ratio of its transmission/CVT, then this estimation can be programmed into the controlling computer so that the controlling computer with the information from the rotational position sensor(s) and transmission ratio sensor(s) can estimate when engagement has occurred so as to stop engaging adjustment.

Another sensor besides the rotational position sensor(s) that can be used to estimate when engagement for torque transmission has occurred so to know when to stop engaging adjustment is a stalling sensor. A stalling sensor simply senses when the adjuster that provides engaging adjustment stalls; here noise (increase in noise might be used to indicate stalling), rotational output of the adjuster (no rotational output of the adjuster when the adjuster is activated might be used to indicate stalling), or maybe a change in current or other measurements, can be used as the item which value triggers the stalling sensor.

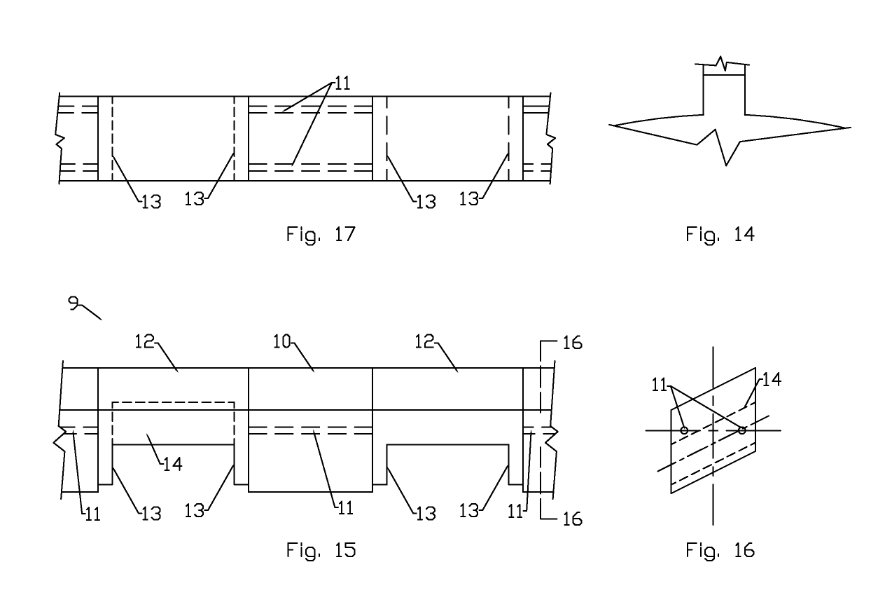

When the “Gap between teeth method” is used no partial/initial engagement between the teeth occur, only final engagement. Therefore, here tooth shapes that allow for smooth partial/initial engagement, such as involute shaped teeth for example, are unnecessary. Here it is desirable to have tooth shapes that provide the largest engagement surface(s) possible and that are easy to manufacture. One such tooth shape is square/rectangular tooth shape, a partial front-view of a square tooth shape of a single tooth cone is shown in FIG. 14; here, the square/rectangular tooth is shaped like an inclined square/rectangular bar, which incline angle should match/corresponds with the incline angle of its single tooth cone, that extends from a smaller end of its single tooth cone to a larger end of its single tooth cone on the surface of its single tooth cone.

A block transmission belt that can be used with the square tooth shape shown in FIG. 14, is shown as a side-view in FIG. 15, as a sectional-view in FIG. 16, and as a top-view in FIG. 17. It is labeled as square teeth block transmission belt 9, and it is an alternate embodiment of this invention. For square teeth block transmission belt 9, its rubber blocks are labeled as rubber blocks 10, its rubber block reinforcements as rubber block reinforcements 11, and its tooth blocks as tooth blocks 12. For clarity the hidden lines in the side-view of one tooth block 12 are not shown (see FIG. 15). The rubber blocks 10 can be attached to their tooth blocks 12 using adhesives.

A tooth block 12 has two parallel end surfaces 13 and an inclined top surface 14. Each parallel end surface 13 has two preferably straight side edges, an inclined bottom edge, and an inclined top edge. Preferably, the incline of the inclined top edge and the inclined bottom edge, should match/correspond to the incline of the tooth it engages, this applies to all tooth blocks of a block transmission belt; however, this might not be necessary, since the inclined top surface 14 or “the inclined top surface of any tooth block” does not necessarily need to come into contact with any portion of the tooth with which its block transmission belt engages.

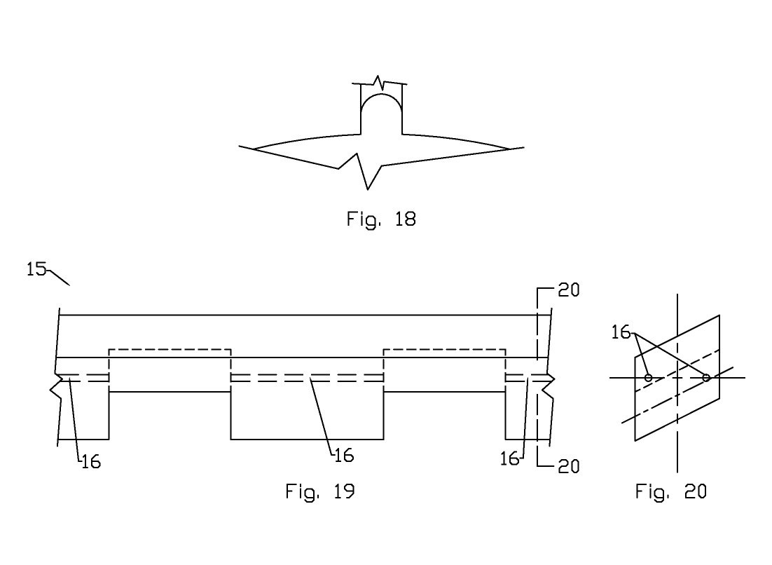

For better engagement with its tooth, it is recommended that the tooth blocks 12 are made out of a flexible material so that they can conform to the circular surface of their cone. If not so, than the end surfaces 13 will not be aligned radially outwards relative to the surface of their cone; and since the tooth with which the end surfaces 13 engage should be aligned radially outwards relative to the surface of its cone, this means that during engagement the end surface 13 that engages for torque transmission with its tooth is not perfectly aligned with the surface of its tooth used for torque transmission. This might result in the top corner of the tooth or another portion of the tooth being engaged with its end surface 13; so that the engagement surface, which size determines the amount of torque that can be transmitted, is very small. One method to resolve this besides making the tooth blocks 12 out of a flexible material is to make the top portion of the square tooth shape of a single tooth cone round instead of square, a partial front-view of such a tooth shape of a single tooth cone is shown in FIG. 18. This increases the engagement surface slightly, however a much larger engagement surface can be obtained by having the end surface 13 that engages for torque transmission with its tooth, aligned with the surface of its tooth used for torque transmission, which can be achieved by making tooth blocks 12 sufficiently flexible.

Another method to have a large engaging surface when using the “Gap between teeth method”, is to use cylindrical shaped teeth for the block transmission belt described earlier (see the section that describes the circular arc tooth profile and the items related to the circular arc tooth profile), and to use cylindrical shaped teeth for the single tooth cone described earlier (see the section that describes the partial cylinder tooth profile and the items related to the partial cylinder tooth profile). All tooth shapes can be used with the “Gap between teeth method” as long as the space where a tooth of a cone will be positioned during engagement with its transmission belt/block transmission belt/chain, is wider than the width of the tooth with which it engages.

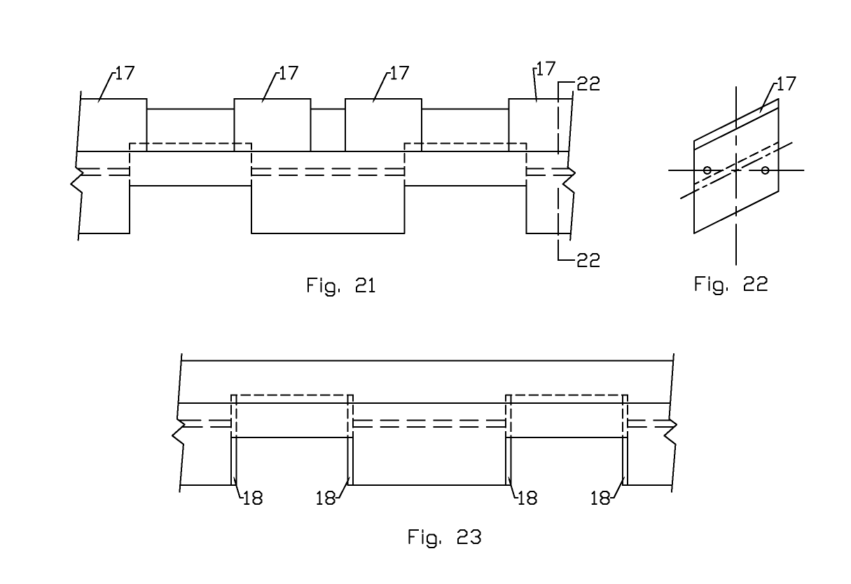

Also instead of a block transmission belt in the shape shown in FIGS. 15 to 17, a rubber belt that is molded in almost the identical shape can be used instead; such a rubber belt, which is labeled as rubber belt 15, is shown as a side-view in FIG. 19 and as a sectional-view in FIG. 20. The reinforcements for rubber belt 15 are labeled as reinforcements 16. The reinforcements in a rubber belt, transmission belt, or block transmission belt, increase the strength of the belt but can be omitted if so desired. Also for a rubber belt such as a rubber belt 15, the bending moment created between the engagement of a tooth of the rubber belt and the tooth of its single tooth cone might cause the belt to deform (this deformation can be made insignificant in a block transmission belt by reducing the flexibility of the tooth blocks/making them very stiff). This deformation can be detrimental to torque transmission and can be reduced by increasing the tension in the slack side of the rubber belt and by using additional supporting pulleys that push the rubber belt towards the surface of its cone. Another method to reduce/eliminate this deformation is by reinforcing the locations of the rubber belt where deformation due to torque transmission can occur by attaching stiff reinforcement plates 17 at to top surface of the rubber belt. A rubber belt on which reinforcement plates 17 are attached, is shown as a side-view in FIG. 21 and as a sectional-view in FIG. 22. Here the length, size, material, location, etc, of the reinforcement plates 17 can be determined using basic engineering principles or trial-and-error. This method, as all methods in this disclosure if applicable, can be used for other belts (this method can be used for other belts where it is desired to reduce deformation of a belt due to torque transmission). Also for a rubber belt, in order to reduce wear that occurs due to the engagement between the teeth of the rubber belt and the tooth/teeth with which they engage, engaging plates 18, can be attached to the engaging surfaces of the rubber belt; as shown in FIG. 23, which shows a side-view of a rubber belt that has engaging plates 18.

As can be seen from FIG. 16 for square teeth block transmission belt 9, the mid-height of the tooth cut-outs of tooth blocks 12, shown as an angled center-line, at the mid-width of tooth blocks 12, are not located at the neutral-axis of rubber blocks 10, shown as a horizontal center-line. In order to have the mid-height of the tooth cut-outs of tooth blocks 12 at the mid-width of tooth blocks 12 located at the neutral-axis of rubber blocks 10, the location of the mid-height of the tooth cut-outs of tooth blocks 12 can be changed or the location of the neutral-axis of rubber blocks 10 can be changed.

In order to change the mid-height of the tooth cut-outs of tooth blocks 12, the height of the bottom end of end surfaces 13 can be raised or lowered and the height of the top end of end surfaces 13 can be raised or lowered. And in order to change the location of the neutral-axis of rubber blocks 10, the location/height of the rubber block reinforcements 11 can be changed and the shape and size of rubber blocks 10 can be changed. Somebody skilled in the art should be able to use basic geometry, basic engineering principles, etc. to adjust the mid-height of a tooth cut-out and to adjust the location of the neutral-axis of a rubber block as desired.

As can be seen from FIG. 20 for rubber belt 15, the mid-height of the tooth cut-outs, shown as an angled center-line, at the mid-width of rubber belt 15, are also not located at the neutral-axis of rubber belt 15. The mid-height of the tooth cut-outs and the neutral-axis can be adjusted using the same/similar methods used for square teeth block transmission belt 9, which were described in the previous 2 paragraphs and can also be used for all other block transmission belts where it is applicable.

Also regarding the tooth shape for the “Gap between teeth method” or tooth shape in general, besides square teeth, triangular teeth and other tooth shapes can be used. And instead of straight surfaces for the engaging surfaces of square teeth, triangular teeth, etc. curved surfaces can be used. Experimentations using a real or computer model and basic engineering principles can be used to determine and shape optimum tooth shape.

If the “Gap between teeth method” is used then the “The transmission ratio for minimal/no adjustment for gap engagement estimation method” can be used. For this method, the controlling computer of the system monitors the “gap engagement adjustment”, which is the amount of rotational adjustment until engagement is achieved for a tooth/teeth of a cone/cone assembly that are positioned in a tooth gap (space) of their transmission belt/chain for each transmission ratio. And from the amount of “gap engagement adjustment” for each transmission ratio, the controlling computer can estimate the transmission ratios where no or minimal “gap engagement adjustments” are required. The system can then be run only at those transmission ratios so as to minimize energy loses due to “gap engagement adjustments”.

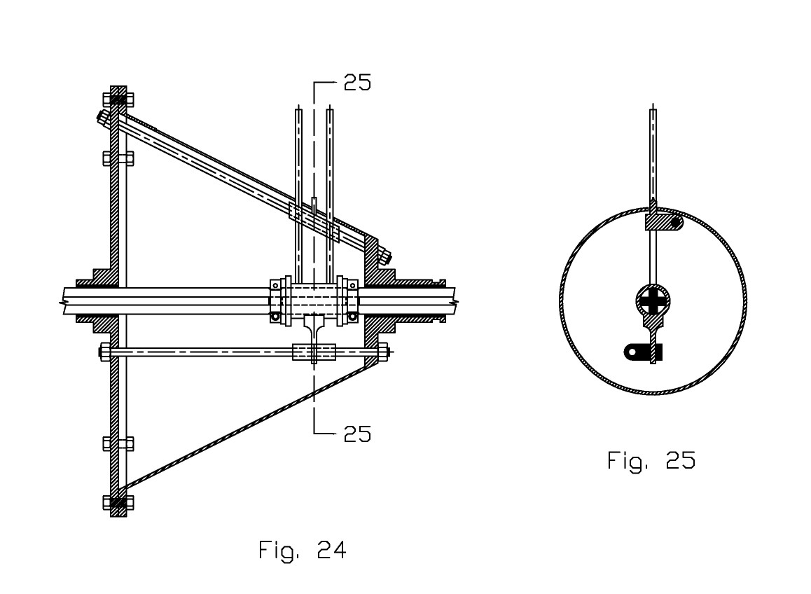

A block transmission belt can also be used with a cone assembly that has one sliding tooth disclosed in patent application Ser. No. 12/459,853. A cone assembly with one sliding tooth is a cone that has a tooth, which is flat and not elongated like the tooth of a single tooth cone and also preferably level instead of inclined at the same/corresponding angle as the incline of its cone, that can be slid from a smaller end of the cone to a larger end of the cone. A cone assembly that has one sliding tooth is shown as a side-view in FIG. 24 and as a sectional-view in FIG. 25.

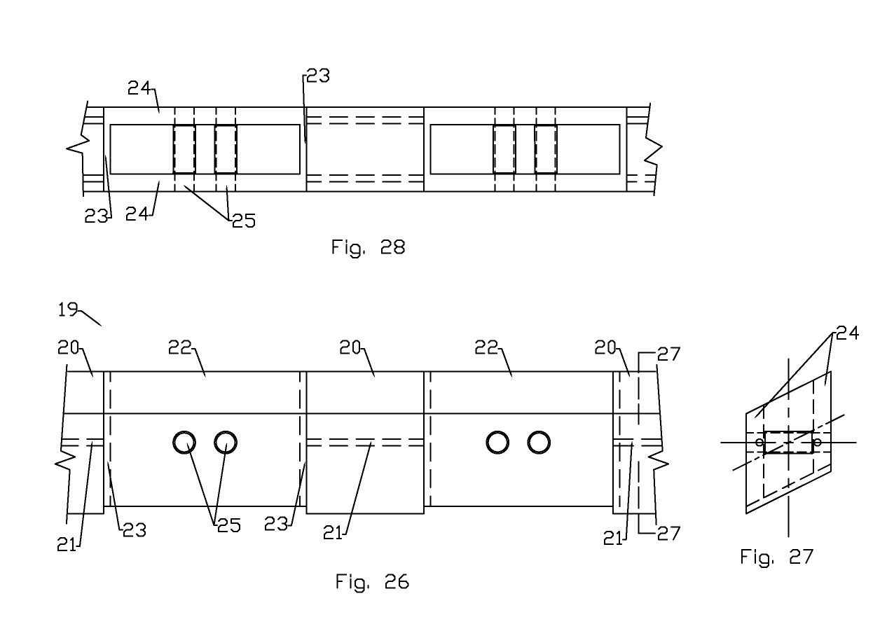

A block transmission belt that can be used with the cone assembly with one sliding tooth of FIGS. 24 and 25 is shown as a side-view in FIG. 26, as a sectional-view in FIG. 27, as a top-view in FIG. 28. It is labeled as sliding tooth block transmission belt 19; and its rubber blocks are labeled as rubber blocks 20, its rubber block reinforcements as rubber block reinforcements 21, and its tooth blocks as tooth blocks 22.

A tooth block 22 is shaped like a six sided box that has two parallel end surfaces 23, two parallel side surfaces 24, an open top surface, and an open bottom surface. In between the two parallel side surfaces 24, two pins 25 are securely positioned, using press fitting, welds, adhesives, or other methods. When the sliding tooth block transmission belt 19 is fully engaged with its sliding tooth, the sliding tooth is positioned between two pins 25, similar in a manner as a sprocket tooth is positioned between two pins of a chain. In order to reduce friction between the pins and their sliding tooth, sleeves of a low friction material can be inserted into the pins, again similar as in a sprocket chain. Obviously, other design features of a sprocket chain that is of some use here can be incorporated as well. Also if only torque transmission in one direction is required than for this design only one pin instead of two is needed, so certainly a sliding tooth block transmission belt 19 with only one pin per tooth block 22 instead of two can also be constructed.

Also the circular arc tooth profiles and the tooth profiles that use the space or portions of the space between two sprocket shaped teeth (see FIGS. 5 to 10) can also be used with a cone assembly with one sliding tooth, except that unlike where it is used for a single tooth cone, here the tooth is flat and not elongated like the tooth of a single tooth cone and also preferably level instead of inclined at the same/corresponding angle as the incline of its cone. Obviously, other tooth profiles, such a tooth profile that has the shape of a sprocket tooth, a square tooth profile, a triangular tooth profile, a partial cylinder tooth profile, etc. can also be used.

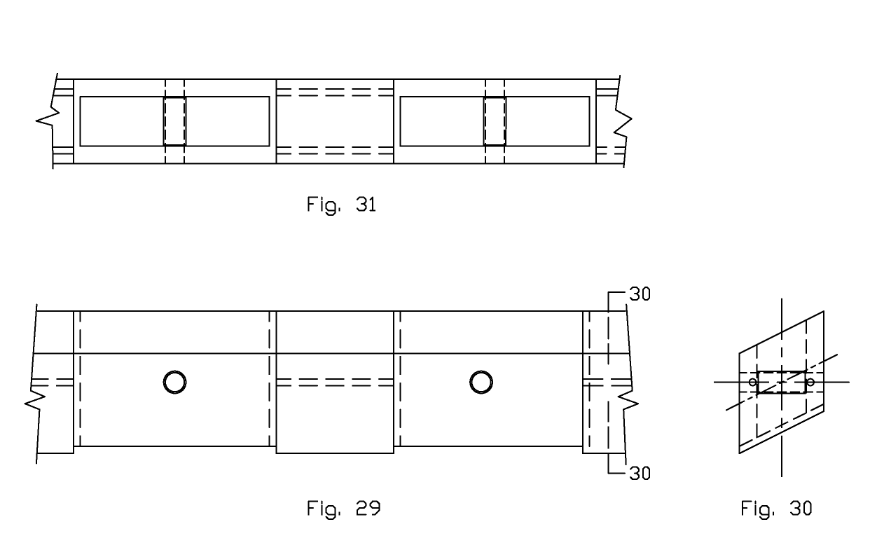

A block transmission belt that can be used with the cone assembly with one sliding tooth that has a sliding tooth that has a circular arc tooth profile or a tooth profile that use the space or portions of the space between two sprocket shaped teeth, is shown as a side-view in FIG. 29, as a sectional-view in FIG. 30, and as a top-view in FIG. 31. This block transmission belt is identical to the block transmission belt shown in FIGS. 26-28, except that it tooth blocks only have one pin instead of two.

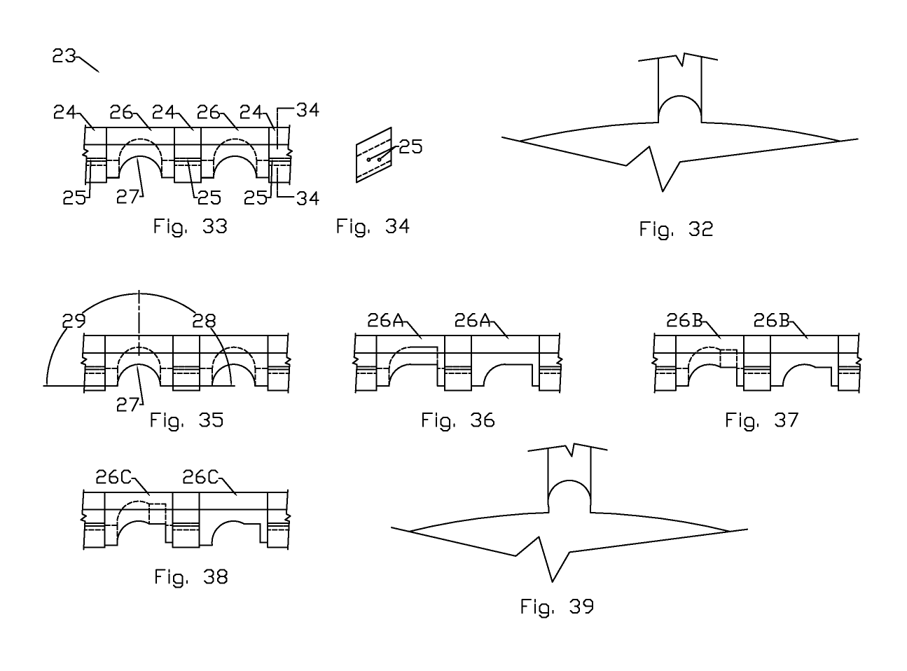

Another alternate tooth profile that can be used as the tooth profile for the single tooth cones and the tooth profile of the teeth of the pulleys to which the single tooth cones are coupled is shown as a partial front-view in FIG. 32. This tooth profile is labeled as the partial cylinder tooth profile.

The lower portion of the partial cylinder tooth profile has the shape of a rectangle, this is shape is of little significance since only the upper portion of the partial cylinder tooth profile engages for torque transmission with its chain or transmission belt, it can have the shape of a square, triangle, or whatever other shape as long as it doesn't interfere or significantly interfere with a surface of the transmission belt or chain with which it engages and as long it has sufficient strength as required by the operation where it is used. If it is determined to be desirable (through experimentation, etc.), the lower portion of the partial cylinder tooth profile can be omitted, so that the partial cylinder tooth profile only consist of the upper portion of the partial cylinder tooth profile, which is described in the next paragraph.

The upper portion of the partial cylinder tooth profile has the shape that is identical to a portion of an inclined cylinder (which inclined angle should correspond to or be identical to the inclined angle of its cone). In FIG. 32, half a portion of an inclined cylinder is used for the partial cylinder tooth profile, a larger or smaller portion can also be used.

Somebody skilled in the art should be able to construct a pulley out of the partial cylinder tooth profile described above. Here, a pulley is similar to a short cone where instead of one tooth multiple teeth are positioned preferably equally spaced apart around the circumference of the cone on the surface of the cone, at the same pitch as the pitch of its transmission belt or chain. Teeth can be skipped if it allows for smoother engagement as long as one tooth is engaged during all instances of the operation of the device where the pulley is used. And in order to maintain the axial alignment of the transmission belt relative to its pulley, the pulley can have flanges.

A block transmission belt that can be used with a partial cylinder tooth profile is shown as a side-view in FIG. 33 and as a sectional-view in FIG. 34. It is labeled as block transmission belt 23; and its rubber blocks are labeled as rubber blocks 24, its rubber block reinforcements as rubber block reinforcements 25, and its tooth blocks as tooth blocks 26.

A tooth block 26 consists of a tooth shape 27. Tooth shape 27 has the shape that is identical to the inner surface of an inclined hollow cylinder, which incline should match the incline of the partial cylinder tooth profile of its single tooth cone and/or pulley with which it engages, for which a portion of the inner surface is removed. Since a portion of the inner surface is removed, in order to specify the amount of the inner surface that is not removed, a rear arc angle 28 and a front arc angle 29 measurement labeling, which both start at the 6 o'clock position, is used (see FIG. 35).

For the tooth of tooth block 26 shown in FIG. 35, the rear arc angle 28 and a front arc angle 29 each measure 90 degrees. The engaging surface measured by rear arc angle 28 provides an engaging surface for torque transmission in one rotational direction and the engaging surface measured by front arc angle 29 provides an engaging surface for torque transmission in the opposite rotational direction from the rotational direction where torque transmission is provided by the engaging surface measured by rear arc angle 28. When not used for torque transmission, the engaging surfaces can also be used to help maintain the shape of the transmission belt with which their partial cylinder tooth profile engages. Here the larger the arc angle, the larger the engaging surface that can be used for torque transmission and the larger the transmission belt shape maintaining support engaging surface. So it is desirable to have the largest rear arc angle 28 and the largest front arc angle 29 that allows for smooth/acceptably smooth torque transmission engagement.

A computer model or a real model can be used to determine the largest rear arc angle 28 and the largest front arc angle 29 that allows for smooth/acceptably smooth engagement between the tooth/teeth of the single tooth cone/pulley and its chain or its transmission belt. Here the interfering surfaces that cause unacceptable engagement (not smooth enough) can be identified and simply removed or reshaped.

Without the use of a model, we can assume that for rotation in the counter-clockwise direction of the single tooth cone which tooth is shown in FIG. 32 (said single tooth cone is on the driving shaft), the engaging surfaces measured by rear arc angle 28 will not allow for smooth/acceptably smooth engagement. In order to allow for smooth/acceptably smooth engagement in the specified direction of rotation, we can simply remove the interfering surfaces that will not allow for smooth/acceptably smooth engagement, which we can assume are the engaging surfaces measured by rear arc angle 28. A side-view of a block transmission belt with alternate tooth blocks 26A, where the engaging surfaces measured by rear arc angle 28 are removed (the rear arc angles 28 are set to 0 degrees) as to allow for smooth/acceptably smooth engagement is shown in FIG. 36. For the tooth blocks 26A, shown in FIG. 36, the spaces of the cut-out tooth shapes of the tooth blocks can be made wider than the width of the tooth/teeth with which they engaged so that these tooth blocks can be used with the “Gap between teeth method”. For clarity the hidden lines in the side-view of one tooth block 26A (the right tooth block 26A) are not shown (see FIG. 36).

The alternate tooth blocks 26A shown in FIG. 36 only allow for proper torque transmission in one direction, since the engaging surface measured by rear arc angle 28 is removed, in order for the CVT/transmission using this tooth profile to work properly it might be necessary to use a clutch that only allows torque transmission in one-direction and that also slips when torque is applied in the direction opposite of the direction that allows torque transmission, or another device or procedure that allows for proper operation of the CVT using this tooth profile. This is certainly an inconvenience; therefore, instead of completely removing the engaging surfaces measured by rear arc angle 28, we might instead reduce the engaging surfaces measured by rear arc angle 28 just enough as to allow for smooth/acceptably smooth engagement (for example instead of setting the rear arc angle 28 to 0 degrees, we might set it to 30 degrees). An example of tooth blocks of a block transmission belt, labeled as alternate tooth blocks 26B, where this is done are shown as a side-view in FIG. 37; for clarity the hidden lines in the side-view of one tooth block 26B are not shown. Here we can use a model and run the model using simulation or an experiment to determine if for example a rear arc angle 28 of 30 degrees allows for smooth/acceptably smooth engagement or not, if not then we need to reduce rear arc angle 28 until a rear arc angle 28 that is small enough to allow for smooth/acceptably smooth engagement is determined, and if yes we can accept a rear arc angle 28 of 30 degrees or increase the rear arc angle 28 until the largest rear arc angle 28 that allows for smooth/acceptably smooth engagement is determined.

A front arc angle 29 that is greater than 90 degrees might also be used, here as described earlier, simulations or experiments using a model can be used to determine the maximum front arc angle 29 that allows for smooth/acceptably smooth engagement, which might be less than 90 degrees. An example of tooth blocks of a block transmission belt with front arc angles 29 that are greater than 90 degrees, labeled as alternate tooth blocks 26C, are shown in as a side-view in FIG. 38; for clarity the hidden lines in the side-view of one tooth block 26C are not shown. For partial cylinder tooth profiles, in order to have proper engagement, the engaging front arc angle of the tooth of the single tooth cone should be greater than the front arc angle 29 of its block transmission belt tooth blocks. A tooth profile for a single tooth cone which has an engaging front arc angle that is greater than 90 degrees so that it can be used with a block transmission belt using tooth blocks 26C is shown as a partial front-view in FIG. 39.

The tooth profiles of the tooth blocks shown in FIGS. 36 to 38, are shaped for counter-clockwise rotation of the single tooth cone or pulley with those tooth profiles engage when said single tooth cone or said pulley is on the input shaft; and shaped for clockwise rotation of said single tooth cone or said pulley when said single tooth cone or said pulley is on the output shaft. For clockwise rotation of said single tooth cone or said pulley when said single tooth cone or said pulley is on the input shaft, and counter-clockwise rotation of said single tooth cone or pulley when said single tooth cone or pulley is on the output shaft, the angle for the rear arc angle 28 and the angle for the front arc angle 29 can simply be swapped, which results in a minor image of the tooth profiles shown in FIGS. 36 and 38.

And instead of having a partial cylinder tooth profile of a single tooth cone shaped like an inclined partial cylinder that has a round cross-section, an inclined partial cylinder that has an elliptical or oval cross-section can also be used as long as the teeth of its block transmission belt/transmission belt/chain are modified accordingly; here experimentations can be performed to see if this has any benefits. A neutral transmission ratio, where there are instance where no single tooth is engaged with its transmission belt can also be used.

Also for all block transmission belts, the position of the tooth blocks relative to their rubber blocks, the position and size of the reinforcements in the rubber blocks, the shape of the teeth of the tooth blocks, the position of the teeth on their tooth blocks, the taper of the tooth of the single tooth cone (which taper for best performance might be different from the taper of its cone because of the change of the curvature of the surface of its cone), the location of the neutral-axis of the rubber blocks relative to the tooth cut-outs/tooth profiles of their tooth block, the rear arc angle and front arc angle of the tooth profiles of the tooth blocks if applicable, etc. can be obtained, improved, and/or optimized using experimentations and tests using a real model, a computer model, etc; engineering principles, mathematics, etc.

Obviously many other design of a block transmission belt can be devised. And all tooth profiles for a single tooth cone can also be used for a cone with two oppositely positioned teeth, a transmission pulley, and other means for conveying rotational energy; and vice-versa (all tooth profiles of a gear, a sprocket, or other means for conveying rotational energy, such as a cog groove tooth shape for example, can also be used for a single tooth cone, a cone with two oppositely positioned teeth, and a transmission pulley).

For a cone with two oppositely positioned teeth, the chain/transmission belt/block transmission belt can only allow smooth operation for certain transmission diameters unless adjustments between the teeth of the cone are provided. Also for proper operations all cones, cone assemblies, and transmission pulleys of this and related to this disclosure, including the single tooth cones, should be balanced for rotation (the centrifugal forces due to the weight of the tooth, torque transmitting member, etc. should be balanced out).

All tooth profiles/tooth shapes of a block transmission belt can also be used for a chain, a regular transmission belt, or other means for conveying rotational energy; and vice-versa (all tooth profiles of a chain, a regular transmission belt, or other means for conveying rotational energy, such as a cog tooth shape for example, can also be used for a block transmission belt).

Obviously, for all rotating means for conveying rotational energy designs, including the cones of this and relevant disclosures (single tooth cone, cone with oppositely positioned teeth, transmission pulleys, etc.), a block transmission belt can be replaced with a regular transmission belt.

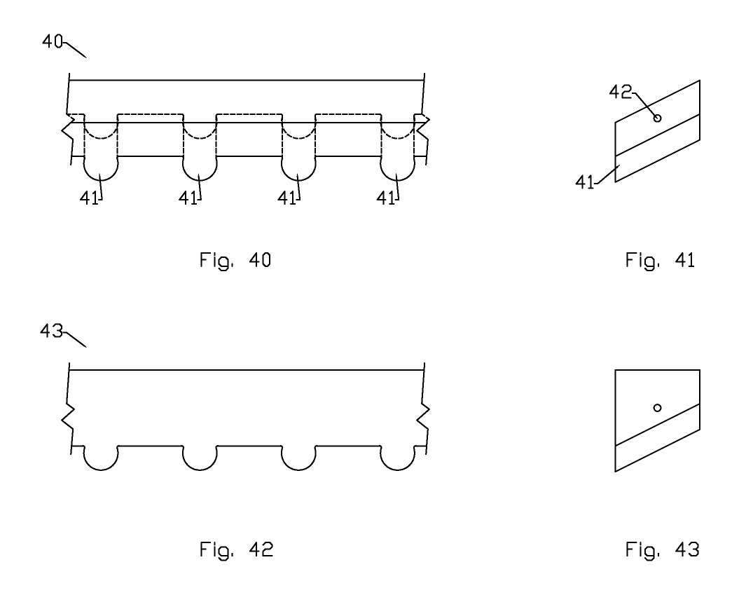

For example, a regular transmission belt, labeled as transmission belt 40, that can be used with the tooth profiles of FIGS. 5, 6, 7, 8, 9 and 10 is shown as a partial side-view in FIG. 40 and as an end-view in FIG. 41. It consists of a tapered belt that has tapered teeth 41. The teeth are used as a resting place for the transmission belt on the surface of its cone. The teeth are shaped like a partial inclined circle or similarly so (partially inclined ovals, partially inclined ellipses, etc.).

In order to increase the strength of transmission belt 40, transmission belt 40 has reinforcements 42. Reinforcement 42 is not shown in FIG. 40 for clarity purposes. As for all transmission belts, including block transmission belts, the reinforcements are optional and do not have to be used. No reinforcement in a transmission belt reduces the cost of the transmission belt and increases the ability of the transmission belt to flex. Flexing of a transmission belt might be desirable to account for transition flexing and to allow for smoother engagement.

For transmission belt 40, the centers of the inclined cylinders of tapered teeth 41, at the mid-width of the transmission belt, are not located at the neutral-axis of the transmission belt. Hence a bending moment is applied to the transmission belt during torque transmission. This can be remedied by the use of a tensioner; or supporting pulleys, rollers or guides that push/holds the transmission belt towards the surface of its rotating means for conveying rotational energy, such it cone or transmission pulley for example. This problem is also encountered with timing belts; all methods to remedy this problem used for timing belts can also be used here and vice-versa. In addition, here we can assume that changes in the distance between the teeth of the transmission belt occur as the transmission diameter of its cone is changed. This issue was discussed earlier for block transmission belts, the description there are also applicable here.

In order to increase the strength of tapered teeth 41, tapered teeth 41 can be reinforced or made out of metal or another preferable material.

An alternate regular transmission belt, labeled as transmission belt 43, that can be used with the tooth profiles of FIGS. 5, 6, 7, 8, 9 and 10 is shown as a partial side-view in FIG. 42 and as an end-view in FIG. 43. This transmission belt is identical to the transmission belt shown in FIGS. 40 and 41 except that it has a straight top surface instead of a tapered top surface. For clarity, the hidden lines in FIG. 42 are not shown, and all descriptions for transmission belt 40 are also applicable here.

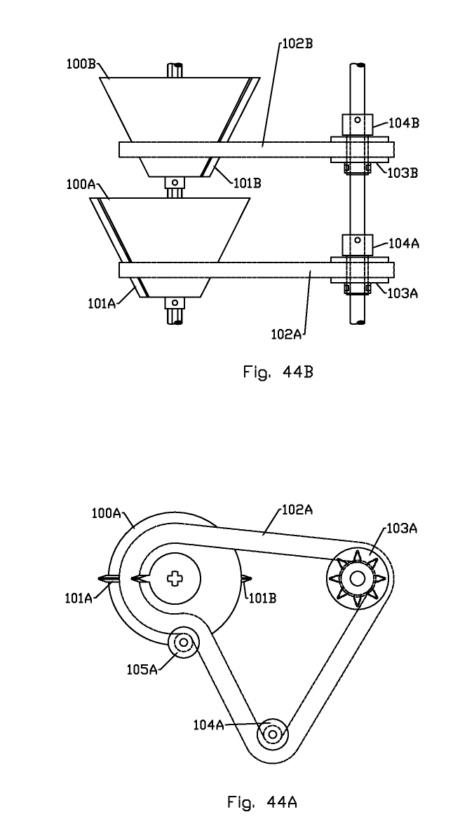

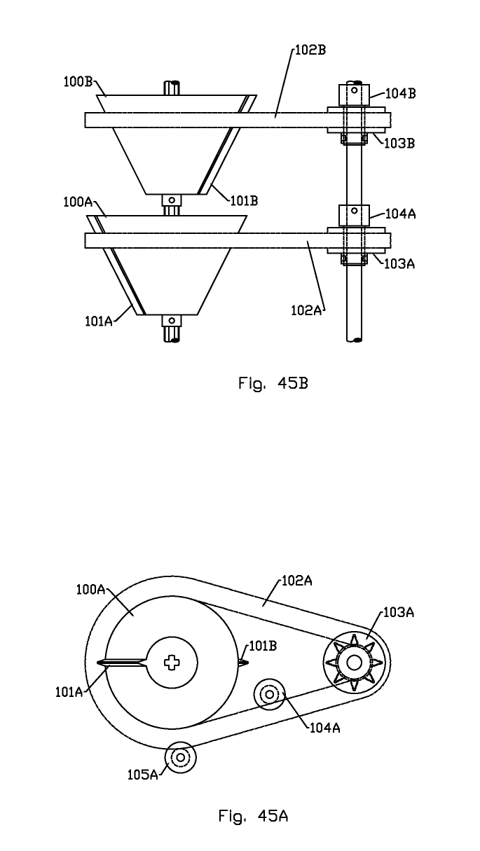

A CVT 2 mainly consists of two single tooth cones, labeled as single tooth cone A 100A and single tooth cone B 100B in FIGS. 44A, 44B, 45A, and 45B, that are mounted on one shaft/spline that are each coupled by a toothed transmission belt to a toothed transmission pulley mounted on another shaft/spline.

Each single tooth cone has one tooth that is used for torque transmission that elongates from a smaller diameter of the cone to a larger diameter of the cone. Since each single tooth cone only has one tooth, in order to ensure that at any instance during the operation of the CVT 2 at least one tooth is engaged with its transmission belt so as to ensure continual torque transmission, the tooth of single tooth cone A 100A is positioned substantially opposite of the tooth of single tooth cone B 100B (substantially opposite doesn't necessarily mean exactly 180 degrees apart, although exactly 180 degrees apart is preferable). So that in instances when single tooth cone A 100A is positioned such that its tooth is not covered by its transmission belt, so that single tooth cone A 100A is not transmitting torque; for single tooth cone B 100B, its tooth is covered by its transmission belt, so that single tooth cone B 100B is transmitting torque, which is due to the engagement between its tooth and its transmission belt. And in instances when single tooth cone B 100B is positioned such that its tooth is not covered by its transmission belt, so that single tooth cone B 100B is not transmitting torque; for single tooth cone A 100A, its tooth is covered by its transmission belt, so that single tooth cone A 100A is transmitting torque, which is due to the engagement between its tooth and its transmission belt. In addition, there can also exist overlapping instances where the tooth of single tooth cone A 100A and the tooth of single tooth cone B 100B are both engaged with their transmission belt, and hence transmit torque, at the same time.

A CVT 2 where the transmission belts are positioned near the smaller end of their single tooth cones is shown as a partial top-view in FIG. 44B and as a partial front-view in FIG. 44A; and a CVT 2 where the transmission belts are positioned near the larger end of their single tooth cones is shown as a partial top-view in FIG. 45B and as a partial front-view in FIG. 45A.

In the figures, the single tooth cones are labeled as single tooth cone A 100A and single tooth cone B 100B, the teeth of the single tooth cones are labeled as tooth A 101A and tooth B 101B, the transmission belts are labeled as transmission belt A 102A and transmission belt B 102B, the transmission pulleys are labeled as transmission pulley A 103A and transmission pulley B 103B, and the adjusters are labeled as adjuster A 104A and adjuster B 104B.

In the figures, transmission belt A 102A and transmission belt B 102B are not accurately drawn, hence the teeth of the transmission belts are not shown. Slightly modified silent chains or inverted teeth chains, which each have a tapered base that matches the taper of its single tooth cone instead of a level base, can be used as a transmission belt A 102A and a transmission belt B 102B. And all transmission belts (block transmission belts, regular transmission belts, etc.) described in this disclosure can also be used as a transmission belt A 102A and transmission belt B 102B.

In FIGS. 44A and 45A, a tensioning pulley A 104A, which is used to maintain the proper tension in transmission belt A 102A as the transmission ratio is changed, is also shown. Although not shown, an identical tensioning pulley, positioned in the same relative position relative to its single tooth cone, also exists for transmission belt B 102B. If desired, the tensioning pulleys can be replaced with idler pulleys, which move into the proper position as to maintain proper tension in their transmission belts as the transmission ratio is changed. Here sliders and slides, electronic/hydraulic positioning, etc. can be used to position the idler pulleys. More details regarding this is described in patent application Ser. No. 12/459,853.

And in FIGS. 44A and 45A, a support pulley A 105A for transmission belt A 102A, which is used with an identical support pulley for transmission belt B 102B (not shown) to ensure that at least one tooth of the single tooth cones is always engaged with its transmission belt during the operation of the CVT 2, is also shown. If the transmission ratio range of the CVT 2 is limited such that at least one tooth of the single tooth cones is always engaged with its transmission belt for all transmission ratios of the CVT 2 without the need of the support pulleys, then the support pulleys can be omitted.

In FIGS. 44A, 44B, 45A, and 45B, the single tooth cones are mounted on a spline. This allows the axial positions of the single tooth cones to be changed relative to the axial position of said spline and hence also relative to the axial positions of their transmission belts and their transmission pulleys. The transmission ratio of the CVT 2 can be changed by changing the axial positions of the single tooth cones relative to the axial positions of their transmission belts and their transmission pulleys. Various guides, pulleys, or other devices that prevent/restrict axial movements of the transmission belts can be used to help maintain the axial position of the transmission belts. The need for maintaining the axial position of a transmission belt also exist in many other devices of prior art, and the methods used there can most likely also be used here, trial and error can be used to make sure; and more details regarding this is described in patent application Ser. No. 12/459,853.

In FIGS. 44A, 44B, 45A, and 45B, both transmission pulleys are mounted on their shaft through the use of an adjuster, if desired only one transmission pulley can be mounted on its shaft through the use of an adjuster. Or instead of using adjusters to mount one or both transmission pulleys to their shaft, one or both single tooth cones can be mounted on their shaft/spline through the use of an adjuster. The adjuster(s) are used to provide adjustments to eliminate/reduce transition flexing and/or adjustments to compensate for transmission ratio change rotation.

Regarding adjustments to eliminate/reduce transition flexing, in instances where the arc length between tooth A 101A and tooth B 101B for the diameter of single tooth cone A 100A and single tooth cone B 100B where their transmission belts are positioned is not a multiple of the width of a tooth (the width of a tooth refers to the width of tooth A 101A, which should have the same width as tooth B 101B), where multiple of the width of a tooth means an arc length of 1 tooth, 2 teeth, 3 teeth, and so forth, such as length 3⅓ teeth for example, then the combination of single tooth cone A 100A and single tooth cone B 100B resemble a sprocket where the number of teeth is not an integer so that it has a partial tooth, such as sprocket with 5¼ teeth, 7⅛ teeth, or 3⅓ teeth for example; where the partial tooth is removed and does not engage with the chain of the sprocket.

For a sprocket with a partial tooth, the tooth positioned immediately after the partial tooth will not engage properly with its chain since that tooth will either be too early or too late relative to its chain Likewise, in instances where the arc length between tooth A 101A and tooth B 101B for the diameter of single tooth cone A 100A and single tooth cone B 100B where their transmission belts are positioned is not a multiple of the width of a tooth, then the tooth about to be engaged will not engage properly with its transmission belt and flexing of that transmission belt, referred to as transition flexing, will occur.

Transition flexing can be eliminated by adjusting the rotational position of the transmission belt that is about to be engaged relative to rotational position of the tooth with which it will engage. For example, let's say tooth A 101A is positioned too late relative to its transmission belt A 102A. Here in order to eliminate transition flexing, transmission belt A 102A can be rotated away from tooth A 101A, so that tooth A 101A is positioned just right relative to its transmission belt for proper engagement to occur. Another example, let's say tooth A 101A is positioned too early relative to its transmission belt A 102A. Here in order to eliminate transition flexing, transmission belt A 102A can be rotated towards tooth A 101A, so that tooth A 101A is positioned just right relative to its transmission belt for proper engagement to occur.

In order adjust the rotational position of transmission belt A 102A relative to its single tooth cone A 100A, and hence also relative to its tooth A 101A, adjuster A 104A, adjuster B 104B, or both adjusters can be used (see FIGS. 44B & 45B). Regarding this, since the rotational position of single tooth cone A 100A relative to single tooth cone B 100B is fixed, in instances where single tooth cone B 100B is engaged with its transmission belt B 102B, the rotational position of single tooth cone A 100A, which is currently not engaged with its transmission belt A 102A, depends on the rotational position of transmission belt B 102B. Hence by adjusting the rotational position of the currently not engaged transmission belt A 102A relative to transmission belt B 102B, the rotational position of transmission belt A 102A relative to single tooth cone A 100A is also adjusted. And the rotational position of transmission belt A 102A can be adjusted relative to transmission belt B 102B by adjusting the rotational position of transmission pulley A 103A relative to transmission pulley B 103B using adjuster A 104A, adjuster B 104B, or both. In the same manner, the rotational position of transmission belt B 102B relative to its single tooth cone B 100B, and hence also relative to its tooth B 101B, can be adjusted using adjuster A 104A, adjuster B 104B, or both.

Although transition flexing can be eliminated using the adjusters, if desired the transmission ratios where transition flexing occurs can be skipped. This might be preferable during cruising. Although in certain instances it might be desirable to skip the transmission ratios where transition flexing occurs, using the adjusters to eliminate transition flexing can still provide improved acceleration and more gradual transmission ratio change, so as to reduce shock loads and jerking during transmission ratio change.

Regarding adjustments to compensate for transmission ratio change rotation, in instances where both tooth A 101A and tooth B 101B are engaged with their transmission belts at the same time, the transmission ratio cannot be changed without some significant amount of stretching in the transmission belts, which is undesirable.

Here depending on the rotational position of a tooth of a single tooth cone, changing the transmission ratio when that tooth is engaged with its transmission belt applies a force that tends to rotate the single tooth cone of that tooth clockwise or counter-clockwise a certain amount. And since for a CVT 2 both single tooth cones are fixed to the same shaft and the rotation due to transmission ratio change for the single tooth cones are different due to that fact that the rotational position of their tooth is different, here changing the transmission ratio when tooth A 101A and tooth B 101B are both engaged with their transmission belt will stretch the transmission belts.

This type of stretching of the transmission belts can be eliminated by rotating the transmission belts relative to each other accordingly using adjuster A 104A, adjuster B 104B, or both adjusters so as to compensate for the difference in the applied rotation due to transmission ratio change of the single tooth cones.

Here the adjusters are used to rotate the transmission pulleys relative to each other which in turn rotates the transmission belts relative to each other. If the transmission pulleys are mounted on the input shaft, then if an adjuster rotates its transmission pulley in the direction opposite of the direction of rotation of the input shaft, then the adjuster only needs to provide a releasing torque. For a releasing torque situation, torque is only needed to overcome friction; lowering a weight using a winch is another example of a releasing torque situation; while raising a weight is not. And if the transmission pulleys are mounted on the output shaft, then if an adjuster rotates its transmission pulley in the direction of rotation of the output shaft, then the adjuster also only needs to provide a releasing torque.

In order to compensate for the difference in the applied rotation due to transmission ratio change of the single tooth cones, only the adjuster that needs to provide a releasing torque needs to be activated. For example, rotating transmission belt A 102A clockwise relative transmission belt B 102B can be achieved either by rotating transmission pulley A 103A clockwise relative to transmission pulley B 103B or by rotating transmission pulley B 103B counter-clockwise relative to transmission pulley A 103A. Here if rotating a transmission pulley in the counter-clockwise direction requires only a releasing torque than only adjuster B 104B can be activated; and if rotating transmission pulley in the clockwise direction requires only a releasing torque than only adjuster A 104A can be activated. The energy required for a releasing torque is insignificant; hence the adjusters will likely consume less energy than a windshield wiper motor.

Here when activated, the adjuster that needs to provide a releasing torque rotates its transmission pulley faster than the speed required to compensate for the difference in the applied rotation due to transmission ratio change of the single tooth cones during transmission ratio change. Here if compensating adjustment is required, the adjuster will provide the required adjustments (the adjuster will slow down or slip if it rotates faster than the required compensating adjustment), and if compensating adjustment is not required the adjusters will simply stall or slip and slightly increase the tension in the transmission belts to an acceptable limit.

The transmission ratio can be changed when only one tooth of a single tooth cone is engaged with its transmission belt; and the adjusters can provide compensation that allows the transmission ratio to be changed when both teeth of the single tooth cones are engaged; so theoretically, through the use of the adjusters there are no instances where the transmission ratio cannot be changed. This allows the transmission ratio to be changed about 30% faster in most instances; and this eliminates any design restriction of the CVT regarding this concern, which can allow an increase in the transmission ratio range and a more efficient design that has less energy loses due to friction.

For adjuster A 104A and adjuster B 104B, a small low power electric motor can be used, since the adjusters only need to overcome frictional resistance, a windshield wiper motor will most likely be more than sufficient. Here an electric motor can be used to drive a worm gear that drives a spur gear that rotates the output shaft of its adjuster; so that the adjuster can lock its output shaft relative to its body when the electric motor is not activated; this is required in order to transmit torque from a “transmission pulley” to “the output shaft of its adjuster” to “the body of its adjuster” and finally to “the shaft on which the body of it adjuster is fixed”. Here in order to allow for large torque transmission, double enveloping worm gear-spur gear drives, such as used in high-torque speed reducers, can be used.

In order to control the adjusters a controlling computer receives input from a rotational position sensor that monitors the rotational position of the single tooth cones shaft, a rotational position sensor that monitors the rotational position of transmission pulley A 103A relative to transmission pulley B 103B, and a transmission ratio sensor. A controlling computer is required in order to properly control the transmission ratio of a CVT used for vehicles subjected to different driving conditions regardless of whether adjusters are used or not, and the cost of two rotational position sensors should not significantly increase the cost of a CVT 2.

The adjustment methods to eliminate/reduce transition flexing and to compensate for transmission ratio change rotation for a CVT 2 using “cones with on one torque transmitting member each” can also be used for a CVT 2 using “cones with one single tooth each (single tooth cones)”. Both a “cone with on one torque transmitting member” and a “cone with one single tooth (single tooth cone)” have only one circumferential section of their cone that is toothed, which we refer to as the “toothed section”. Said adjustment methods do not depend on the amount of teeth in a said “toothed section”, so the adjustment methods for a CVT 2 using “cones with on one torque transmitting member each” can also be used for a CVT 2 using “cones with one single tooth each (single tooth cones)”, this is certainly true for the adjustment method to eliminate/reduce transition flexing and the over adjustment method to compensate for transmission ratio change rotation. Detailed descriptions regarding said adjustment methods can be found in patent application Ser. No. 12/459,853.

If desired a CVT 2 with no adjusters can also be constructed. For this CVT 2 the transmission ratios where transition flexing occur can be skipped, the transmission ratio of the CVT can be maintained at a transmission ratio where no transition flexing occur, and/or transmission belts that are designed to allow sufficient flexing to account for transition flexing can be used.

If adjustments to compensate for transition flexing is provided by rotating one transmission pulley relative to another so as to adjust the rotational position of a transmission belt relative to its cone, then it is recommended that adjustments to compensate for transition flexing are provided in the direction of rotation that increases the tension in the tense side of said transmission belt. Here if the transmission pulleys are mounted on the input shaft then said transmission belt should be rotated in the direction of rotation of the input shaft relative to its cone, and if the transmission pulleys are mounted on the output shaft then said transmission belt should be rotated in the opposite direction of rotation of the output shaft relative to its cone.

If adjustment to compensate for transition flexing is provided in the direction of rotation that decreases the tension in the tense side of a transmission belt which rotational position is adjusted relative to its cone, then said adjustment will increase the tension in the slack side of said transmission belt. Here depending on the friction between said transmission belt and its cone, the adjustment provided might change the position of the tensioning pulley (if used instead of an idler pulley) of said transmission belt and this can decrease the accuracy and increase the response time of the adjustment provided. Here experimentation can be performed to determine whether this will significantly reduce the performance and reliability of the CVT.

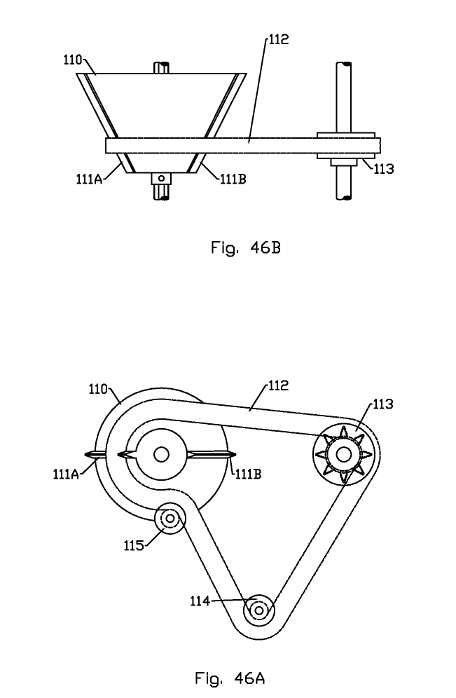

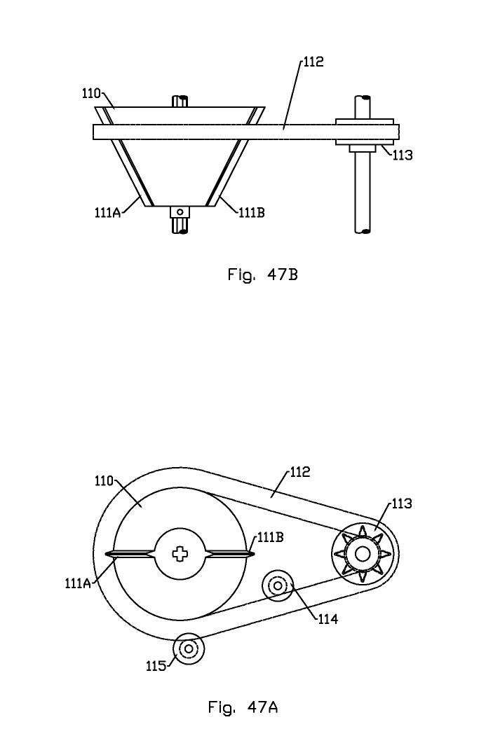

A CVT 3 mainly consists of a cone with two oppositely positioned teeth (oppositely positioned teeth doesn't mean that the teeth have to be positioned exactly 180 degrees apart, but 180 degrees apart or close to 180 degrees apart), labeled as opposite teeth cone 110 in FIGS. 46A, 46B, 47A, and 47B, that is mounted on a shaft/spline that is coupled by a toothed transmission belt to a toothed transmission pulley mounted on another shaft/spline. Each tooth of said opposite teeth cone 110 elongates from a smaller diameter of the cone to a larger diameter of the cone.

A CVT 3 where the transmission belt is positioned near the smaller end of its cone with two oppositely positioned teeth is shown as a partial top-view in FIG. 46B and as a partial front-view in FIG. 46A; and a CVT 3 where the transmission belt is positioned near the larger end of its cone with two oppositely positioned teeth is shown as a partial top-view in FIG. 47B and as a partial front-view in FIG. 47A.

In the figures, the teeth of opposite teeth cone 110 are labeled as tooth 111A and tooth 111B, the transmission belt is labeled as transmission belt 112, and the transmission pulley is labeled as transmission pulley 113.

In the figures, transmission belt 112 is not accurately drawn; hence the teeth of the transmission belt are not shown. Slightly modified silent chains or invert teeth chains, which each have a tapered base that matches the taper of its single tooth cone instead of a level base, can be used as transmission belt 112. And all transmission belts (block transmission belts, regular transmission belts, etc.) described in this disclosure can also be used as a transmission belt 112.

In FIGS. 46A and 47A, a tensioning pulley 114, which is used to maintain the proper tension in transmission belt 112 as the transmission ratio is changed, is also shown. If desired it can be replace with an idler pulley, which moves into the proper position as the transmission ratio is changed. Here sliders and slides, electronic/hydraulic positioning, etc. can be used to position the idler pulley. More details regarding this is described in patent application Ser. No. 12/459,853.

And in FIGS. 46A and 47A, a support pulley 115 for transmission belt 112 that is used to ensure that at least one tooth of opposite teeth cone 110 is always engaged with transmission belt 112 during the operation of the CVT 3, is also shown. If the transmission ratio range of the CVT 3 is limited such that at least one tooth of opposite teeth cone 110 is always engaged with transmission belt 112 for all transmission ratios of the CVT 3 without the need of the support pulleys, then the support pulleys can be omitted.

In FIGS. 46A, 46B, 47A, and 47B, opposite teeth cone 110 is mounted on a spline. This allows the axial position of opposite teeth cone 110 to be changed relative to the axial position of said spline and hence also relative to the axial positions of its transmission belt and its transmission pulley. And the transmission ratio of the CVT 3 can be changed by changing the axial position of the opposite teeth cone 110 relative to the axial positions of its transmission belt and its transmission pulley. Various guides, pulleys, or other devices that prevent/restrict axial movements of the transmission belt can be used to help maintain the axial position of the transmission belt. The need for maintaining the axial position of a transmission belt also exist in many other devices of prior art, and the methods used there can most likely also be used here, trial and error can be used to make sure; and more details regarding this is described in patent application Ser. No. 12/459,853.

The CVT 3 shown in FIGS. 46A, 46B, 47A, and 47B does not use an adjuster, hence no adjustments to eliminate/reduce transition flexing can be provided. Therefore for the CVT 3 shown in FIGS. 46A, 46B, 47A, and 47B, the transmission ratios where transition flexing occur can be skipped, the transmission ratio of the CVT can be maintained at a transmission ratio where no transition flexing occur, and/or a transmission belt that is designed to allow sufficient flexing to account for transition flexing can be used.

If desired a CVT 3 that uses a “cone with one fixed tooth and one oppositely positioned adjustable tooth” can be used instead of a “cone with two oppositely positioned fixed teeth”. For a “cone with one fixed tooth and one oppositely positioned adjustable tooth”, the “adjustable tooth” can be coupled to an adjuster as is done for an “adjustable torque transmitting member” of a “cone assembly with one fixed torque transmitting member and one oppositely positioned adjustable torque transmitting member” described in patent application Ser. No. 12/459,853.

The adjustment method to eliminate/reduce transition flexing for a “cone with one fixed tooth and one oppositely positioned adjustable tooth” is identical to the adjustment methods to eliminate/reduce transition flexing for a “cone assembly with one fixed torque transmitting member and one oppositely positioned adjustable torque transmitting member”. Both a “cone assembly with one fixed torque transmitting member and one oppositely positioned adjustable torque transmitting member” and a “cone with one fixed tooth and one oppositely positioned adjustable tooth” have two oppositely positioned circumferential section on their cone that are toothed, which we refer to as a “toothed section” (oppositely positioned “toothed sections” doesn't mean that the “toothed sections” have to be positioned exactly 180 degrees apart, but 180 degrees apart or close to 180 degrees apart; if one “toothed section” is adjusted relative to the other “toothed section”, then there should be instances where the “toothed sections” are not positioned exactly 180 degrees apart). Said adjustment method do not depend on the amount of teeth in a said “toothed section”, so the adjustment method to eliminate/reduce transition flexing for a “cone with one fixed tooth and one oppositely positioned adjustable tooth” is identical to the adjustment method to eliminate/reduce transition flexing for a “cone assembly with one fixed torque transmitting member and one oppositely positioned adjustable torque transmitting member”.

The adjustment methods to eliminate/reduce transition flexing for a “cone assembly with one fixed torque transmitting member and one oppositely positioned adjustable torque transmitting member” is described in patent application Ser. No. 12/459,853 for a cone assembly of a CVT 1.1, which is also applicable for a cone assembly of a CVT 3 that has a cone/cone assembly with on fixed and one oppositely positioned adjustable “toothed section”.

Also for the adjustment method to eliminate/reduce transition flexing, the adjustments provided to the adjustable “toothed section” is very little. So that after a said adjustment is provided from a relative rotational position where the “toothed sections (teeth or torque transmitting members)” are exactly or almost exactly opposite, the “toothed sections” are still substantially oppositely positioned. In order to ensure that the “toothed sections” are always substantially oppositely positioned, it is recommended that the “toothed sections” are returned to the relative rotational position where the “toothed sections” are exactly or almost exactly opposite positioned every time after a said adjustment has been provided, so that every time before a said adjustment is provided, the “toothed sections” are exactly or almost exactly opposite positioned.

The operation of the mover adjusters in order to substantially increase the duration at which the transmission ratio can be changed for a cone assembly of a CVT 1.1 described in patent application Ser. No. 12/459,853 can also be used for a cone/cone assembly of a CVT 3.

I claim:

1. An new tooth profile for a block transmission belt.
